(19) United States
(12) Patent Application Publication
(10) Pub. No.: US 2014/0321885 A1
(43) Pub. Date: Oct. 30, 2014

(54) TONER-CONTAINER SUPPORT UNIT AND IMAGE-FORMING APPARATUS

(71) Applicants: Akira FUJIMORI, Yokohama-shi (JP); Hideki KOSUGI, Yokohama-shi (JP); Tatsuya KUBO, Kawasaki-shi (JP); Kentaro NODERA, Sagamihara-shi (JP); Shinnosuke KOSHIZUKA, Yamato-shi (JP); Teppei KIKUCHI, Yokohama-shi (JP)

(72) Inventors: Akira FUJIMORI, Yokohama-shi (JP); Hideki KOSUGI, Yokohama-shi (JP); Tatsuya KUBO, Kawasaki-shi (JP); Kentaro NODERA, Sagamihara-shi (JP); Shinnosuke KOSHIZUKA, Yamato-shi (JP); Teppei KIKUCHI, Yokohama-shi (JP)

(21) Appl. No.: 14/263,094

(22) Filed: Apr. 28, 2014

(30) Foreign Application Priority Data
Apr. 30, 2013 (JP) 2013-095231

(51) Int. Cl. G03G 15/08

(52) U.S. Cl. CPC G03G 15/0875; G03G 15/80
USPC 399/258

(57) ABSTRACT

A toner-container support unit is provided. The toner-container support unit includes: a toner container housing toner; a container mount including an internal space to accommodate the toner container; a toner-container receiver which is provided on an internal end side of the internal space of the container mount; a positioning hole formed on the back end surface of the toner container; a positioning pin provided in the toner-container receiver; a retracting assembly retracing a back end portion of the toner container to the toner-container receiver side when inserting the toner container into the container mount; and an inclination stopper which prevents the inclination of the toner container when the back end portion of the toner container is retracted by the retracting assembly toward the toner-container receiver.

### CROSS-REFERENCE TO RELATED APPLICATION

The present application is based on and claims priority from Japanese Patent Application No. 2013-95231, filed on Apr. 30, 2013, the disclosure of which is hereby incorporated by reference herein in its entirety.

### BACKGROUND

### Field of the Invention

The present invention relates to a toner-container support unit in which a toner container housing toner is supported on an image-forming apparatus, and an image-forming apparatus including the toner-container support unit.

Generally, a toner container housing toner is inserted into an image-forming apparatus such as a copier, printer, facsimile device, and multifunction peripheral. That is, the image-forming apparatus includes a container mount having a space inside thereof. The toner container is inserted into the space of the container mount. The toner container is configured to be detachable and attachable, and can be replaced with a new one when toner inside runs out.

The image-forming apparatus further includes a fixed protrusion formed on a back surface of the toner container, and a movable protrusion formed on an inner surface of the internal space of the container mount. A so-called retracting assembly is further included in the image-forming apparatus. The toner container is retracted toward deep inside the internal space of the container mount by the retracting assembly when it is inserted into the container mount. In the retracting assembly, when the toner container is inserted into the container mount, the movable protrusion contacts the fixed protrusion, and the fixed protrusion pushes the movable protrusion so that it can cross over the fixed protrusion. Because the movable protrusion is configured to have a biasing force toward the outer direction, it tries to turn back by the biasing force when crossing over the fixed protrusion. Thus, the end portion of the toner container is drawn back to deep inside the internal space of the container mount.

However, in the above-described image-forming apparatus, there is a problem in that the toner container should incline when it is retracted by the retracting assembly. In detail, the fixed protrusion is disposed on a lower position of the external back-wall surface of the container and the movable protrusion is similarly disposed on a lower position of the internal back-wall surface of the container mount. Thus, the back part of the toner container moves up due to the biasing force applied to the lower part of the container, so the toner container inclines when it is retracted by the retracting assembly.

Generally, a positioning hole for adjusting a position of the toner container and a positioning pin are provided on the back end surface of the toner container and an inner side surface of the internal space of the container mount. However, the position of the positioning hole doesn't match that of the positioning pin if the toner container inclines; therefore, the position-adjustment pin cannot fit into the positioning hole.

### SUMMARY

The present invention is therefore made to provide a toner-container support unit capable of preventing an inclination of a toner container when the toner container is retracted by a retracting assembly, and an image-forming apparatus including such a structure.

In order to accomplish the above-described object, the toner-container support unit according to the present embodiments includes: a toner container housing toner; a container mount including an internal space to accommodate the toner container; a toner-container receiver which is provided on an internal end side of the internal space of the container mount, fixing and supporting a back end surface of the toner container inserted into the container mount; a positioning hole formed on the back end surface of the toner container; a positioning pin provided in the toner-container receiver so as to face the positioning hole; a retracting assembly retracing a back end portion of the toner container to the toner-container receiver side when inserting the toner container into the container mount, a position of the toner container being adjusted by fitting the positioning pin into the positioning hole through the retracting assembly retracting the back end portion of the toner container; and an inclination stopper which prevents the inclination of the toner container when the back end portion of the toner container is retracted by the retracting assembly toward the toner-container receiver.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 illustrates an entire configuration of an image-forming apparatus 102 according to Embodiment of the present invention.

FIG. 2 provides an explanatory view illustrating a configuration of a process cartridge 20 and a toner cartridge 502 according to Embodiment.

FIG. 3 provides a schematic view illustrating the toner cartridge 502 and a peripheral configuration of the toner cartridge 502 in a case it is inserted into a toner-supply device 43 according to Embodiment.

FIG. 4 provides a perspective view of the toner cartridge 502 as viewed from the top front side (in direction Z).

FIG. 5 provides a perspective view of the toner cartridge 502 as viewed from the top front side and in a direction which is different from that of FIG. 4 in the left and right direction.

FIG. 6 provides a perspective view of the toner cartridge 502 as viewed from the bottom front side (in direction Z).

FIG. 7 provides a front view of the toner cartridge 502 as viewed from the front side.

FIG. 8 provides a perspective view of the toner cartridge 502 as viewed from the top front side, illustrating a partial cross-sectional view along the V-V line shown in FIG. 7 (in direction Z including the V-V line section).

FIGS. 9A to 9C provide explanatory views illustrating a configuration of a coupling 522a in a stirring member 52 shown in FIG. 8. FIG. 9A is a perspective view illustrating the coupling 522a as viewed from the front side (in direction Z). FIG. 9B is a side view of the coupling 522a (perpendicular to direction Z). FIG. 9C is a cross-sectional view illustrating the coupling 522a along the VI-VI line shown in FIG. 9A.

FIGS. 10A to 10E provide explanatory views illustrating the configuration and function of the coupling 522a in the stirring member 52, and a stirring-drive coupling 301 of the toner-supply device 43. FIG. 10A schematically illustrates the stirring-drive coupling 301 and the coupling 522a as viewed from the perpendicular side to the direction Z. FIG. 10B schematically illustrates a hook protrusion 301a of the stirring-drive coupling 301 and a hook protrusion 522b of the coupling 522a as viewed from a direction indicated with an arrow A9 shown in FIG. 10A. FIG. 10C illustrates a motion of the hook protrusions 301a and 522b relative to the guiding functions of an inclination surface 301c in the hook protrusion 301a and an inclination surface 522d in the hook protrusion 522b. FIG. 10D illustrates an aspect in which the stirring-drive coupling 301 is connected to the coupling 522a. FIG. 10E illustrates an inclination 522f which is provided on an end portion 522c of one of a pair of hook protrusions 522b, and an inclination 301d which is provided on a protruding end portion 301b of one of a pair of hook protrusions 301a.

FIG. 11 provides a perspective view illustrating the toner cartridge 502 as viewed from the top rear side (opposite to direction Z).

FIG. 12 provides a perpendicular view illustrating the toner cartridge 502 as viewed from the top rear side in a direction different from that of FIG. 11 in the right and left direction.

FIG. 13 provides a perspective view illustrating a partially enlarged bottom-aspect of the toner cartridge 502.

FIG. 14 provides an explanatory view illustrating a configuration of a first shutter 622 provided in a shutter assembly 602 of the toner cartridge 502.

FIGS. 15A to 15C provide explanatory views illustrating a configuration of a second shutter 632 in the shutter assembly 602. FIG. 15A illustrates a front view of the second shutter 632 as viewed from the top side. FIG. 15B illustrates a perspective view of the second shutter 632 as viewed from the top side and in the opposite direction to the insertion direction (opposite to direction Z). FIG. 15C illustrates a perspective view of the second shutter 632 as viewed from the top side and the forward side of the inserting direction.

FIG. 16 provides an explanatory view illustrating a configuration of the shutter assembly 602 comprised of the first shutter 622 and the second shutter 632 incorporated with the bottom surface of a container portion 51 (toner cartridge 502).

FIG. 17 provides an explanatory view of the container portion 51 shown in FIG. 3, illustrating a cross-sectional view along the VII-VII line (Y-Z plan surface of including VII-VII line section).

FIG. 18 provides a perspective view of a toner-container fixing portion 902 of the toner-supply device 43.

FIG. 19 provides a front view of the toner-container fixing portion 902 as viewed from the top side (direction Y).

FIG. 20 provides an explanatory view schematically illustrating an image-forming apparatus 102.

FIGS. 21A to 21B provide explanatory views illustrating a relationship between a container mount 220 (toner-container fixing portion 902) of the image-forming apparatus 102 and the toner cartridge 502. FIG. 21A illustrates an aspect while inserting the toner cartridge 502 into the container mount 220. FIG. 21B illustrates an aspect in which the toner cartridge 502 is inserted into the container mount 220.

FIG. 22 provides a perspective view illustrating a configuration of the container mount 220 (toner-container fixing portion 902).

FIGS. 23A to 23C provide explanatory views illustrating functions of a holding rail 209 in a side wall section 50c of the toner cartridge 502, and a holding rail 221 of the container mount 220. FIG. 23A illustrates an aspect in which the holding rail 209 faces the holding rail 221 in the direction Z. FIG. 23B illustrates an aspect in which the holding rail 209 contacts the holding rail 221. FIG. 23C illustrates an aspect in which the holding rail 209 overlaps the holding rail 221 in the direction Y.

FIG. 24 provides an explanatory view illustrating an aspect in which the toner cartridge 502 is inserted to the toner-container fixing portion 902. FIG. 24 includes a cross-sectional view of the toner cartridge 502 similar to FIG. 16 and a front view of the toner-container fixing portion 902 similar to FIG. 19. FIG. 24 further illustrates a pair of pressure portions 212 having an opening. FIG. 24 also illustrates a pressure body 212b, a protruding end portion 212c, and an inclining pressure-surface 212d of the pressure portion 212 having contact with a releasing protrusion 812d (and inclined releasing surface 812e thereof) of a pair of arm sections 812, as a primary incurve-condition of the second shutter 632 of the toner cartridge 502.

FIG. 25 provides an explanatory view similar to FIG. 24, and illustrates the second shutter 632 of the toner cartridge 502 having contact with a second step portion 98 of the toner-container fixing portion 902.

FIG. 26 provides an explanatory view similar to FIG. 24, and illustrates a discharge outlet 55 of the toner cartridge 502 in connection with a toner-supply port 96a of the toner-container fixing portion 902 (toner-supply device 43).

FIG. 27 provides an explanatory view similar to FIG. 24, illustrating an aspect in which the toner cartridge 502 is discharged. FIG. 27 illustrates a release aspect of the fixed toner cartridge 502 released by a pair of releasing claw assemblies 97 when the toner cartridge 502 moves to the opposite side of the direction Z relative to the toner-container fixing portion 902.

FIG. 28 provides an explanatory view similar to FIG. 24, and illustrates an aspect in which the second shutter 632 which is fixed by each hook piece 812b and fixing grooves 93 is released, through which the toner cartridge 502 moves to the direction opposite to the Z-axis relative to the toner-container fixing portion 902.

FIG. 29 provides a perspective view of a receiver 905 of the toner cartridge 502.

FIG. 30 shows a configuration according to Embodiment, illustrating an aspect in which the toner cartridge 502 can be kept horizontal when it is inserted into the toner-container mount 220 of the image-forming apparatus 102.

FIG. 31 shows a configuration of a conventional art. FIG. 31 illustrates an aspect in which the toner cartridge 502 inclines when it is inserted into the container mount 220.

FIGS. 32A and 32B provide explanatory views to illustrate an effect of the positions of the first positioning hole 201 and the second positioning hole. FIG. 32A schematically illustrates the inner side of the toner cartridge 502. FIG. 32B schematically illustrates the inner side aspect of a toner cartridge 502′ as a comparative example.

FIG. 33 is a perspective view of a toner cartridge 503 having a different configuration from the toner cartridge 502, as viewed from the top front side (direction Z).

### DETAILED DESCRIPTION OF THE PREFERRED EMBODIMENT

### Embodiment

Hereinafter, Embodiment of a toner-container support unit and an image-forming apparatus according to the present invention will be described with reference to the drawings. Identical or corresponding parts are designated with the same numerals and symbols throughout the drawings, and the descriptions thereof are simplified or omitted arbitrary so as to avoid repetition.

A toner cartridge 502 (502Y, 502C, 502M, 502BK) and an image-forming apparatus 102 capable of accommodating the toner cartridge are described below. Initially, a configuration and operation of the image-forming apparatus 102 are described.

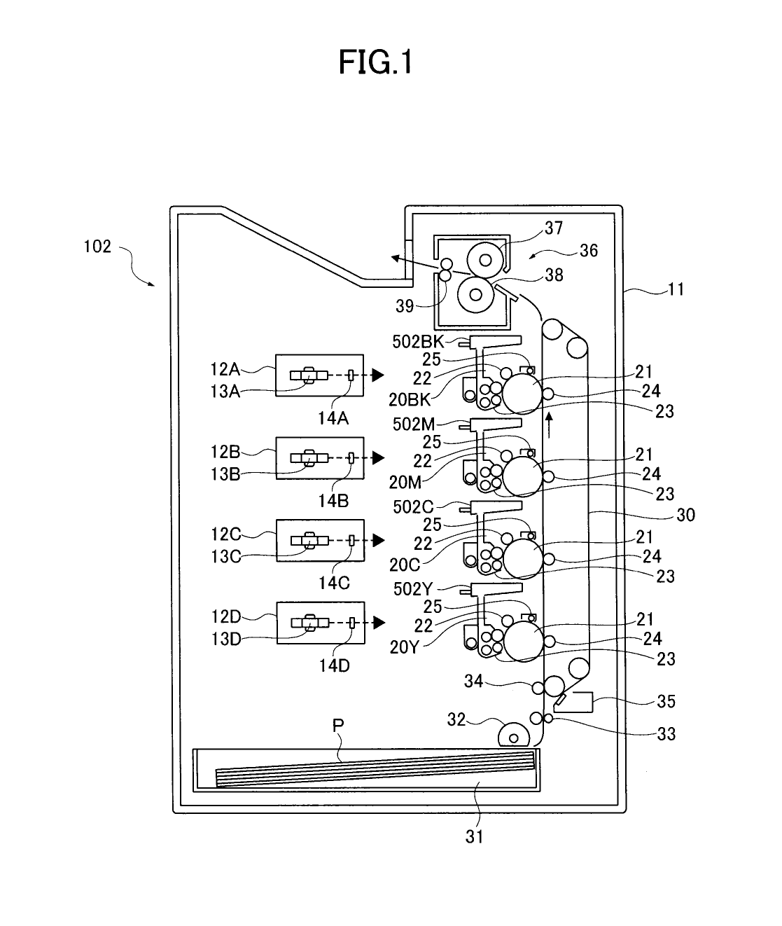

The image-forming apparatus 102 according to the present embodiment is a multicolor printer as shown in FIG. 1 and includes a box-shaped main body 11 as a housing body. The image-forming apparatus 102 includes writing units 12A to 12D to write electrostatic latent images on photoreceptor drums 21 (image bearer) according to image data after a charging process. The writing units 12A to 12D can be optical scanning devices employing polygon mirrors 13A to 13D, optical elements 14A to 14D, and the like. Alternatively, an array of light-emitting diodes (LED) may be used as the writing units. The electrostatic latent images formed by the writing units 12A to 12D are developed and transferred onto a transfer material P as a recording media and stacked in a paper feeder 31.

The transfer material P can be recording paper, overhead projector films (OHP), and so on. Many sheets of these are stacked in the paper feeder 31. In the image formation, the stacked transfer material P is sent out from the top to a transfer belt 30 as a feed roller 32 rotates. The transfer belt 30 has an endless form and transports the transfer material P having an electrostatically-absorbed surface. The transfer belt 30 transfers a toner image formed on the photoreceptor drum 21 to the transfer material P. The transfer belt 30 revolves around a definite path including neither a start-edge nor an end-edge. An absorbing roller 34 and a belt-cleaning device 35 are provided on an outer circumferential surface of the transfer belt 30.

The photoreceptor drum 21 faces a respective transfer roller 24 via the transfer belt 30. Each transfer roller 24 includes a not-shown metal core and a conductive elastic layer covering the metal core. The conductive elastic layer of the transfer roller 24 is constructed of an elastic material such as polyurethane rubber or ethylene-propylene-diene polyethylene (EPDM), and its electrical resistance value (volume resistivity) is adjusted to a medium value with dispersion of a conductive applicator such as carbon black, zinc oxide, tin oxide, or the like. A fixing device 36 is provided above the revolving transfer belt 30 as shown in FIG. 1. The fixing device 36 includes a pressure roller 37 and a heating roller 38 to fix the toner image on the transfer material P with heat and pressure.

In FIG. 1, four process cartridges 20Y, 20C, 20M and 20BK are arranged vertically along the transfer belt 30. The four process cartridges 20 form yellow, cyan, magenta and black toner images. A device to supply carrier (magnetic carrier particles) and each color (yellow, cyan, magenta, and black) of toner (toner particles) to respective developing devices 23 is provided above each process cartridge 20Y, 20C, 20M and 20BK. That is, toner cartridges 502Y, 502C, 502M and 502BK containing carrier or toner are provided on the respective process cartridges 20Y, 20C, 20M and 20BK as the supply device.

The process cartridges 20Y, 20C, 20M, 20BK and the toner cartridges 502Y, 502C, 502M and 502BK can be mounted to the main body 11 and removed therefrom when the transfer belt 30 rotates around a rotation shaft (not shown).

In Embodiment, the image-forming apparatus 102 performs as a multifunction peripheral such as a copier or printer. When the image-forming apparatus 102 performs as a copier, various types of image processing, such as analog and digital conversion, MTF correction, gradation processing is provided on image data read by a scanner. The image data is converted into image-writing data after such image processings. When the image-forming apparatus 102 performs as a printer, image data in a form of page-description language, bitmap or the like, which is transmitted from a computer and so on, is processed into the image-writing data.

In image formation, the writing units 12A to 12D emit exposure light according to image data of black, magenta, cyan, and yellow toward the respective process cartridges 20BK, 20M, 20C, and 20Y. That is, the exposure light (laser beam) emitted from each light source of the writing units 12A to 12D irradiates the photoreceptor drums 21 through the polygon mirrors 13A to 13D, and the optical elements 14A to 14D. Thereby, a toner image corresponding to each exposure light is formed on the photoreceptor drum 21 (image bearer) of each process cartridge 20Y, 20C, 20M, and 20BK. Then, the toner image is transferred to the transfer material P.

The transfer material P fed from the paper feeder 31 stops temporarily at a position of a registration roller 33 and is forwarded to the transfer belt 30. Specifically, the registration roller 33 rotates coincident with the passage of the transfer material P through the photoreceptor drum 21 (image bearer) where the toner image is formed. The transfer belt 30 absorbs the transfer material P entered by application of a voltage through the absorbing roller 34 disposed on an entry position of the transfer belt 30. Thereby, the transfer material P moves along the rotation of the transfer belt 30 in a direction indicated by an arrow shown in FIG. 1. While the transfer material P passes through each process cartridge 20Y, 20C, 20M, and 20BK sequentially, respective toner image having each color is superimposed thereon.

Thus the transfer material P including the transferred color image is separated from the transfer belt 30 and reaches the fixing device 36. The toner image on the transfer material P is fixed thereon while it is sandwiched and heated between the pressure roller 37 and the heating roller 38. Therefore, the surface of the transfer belt 30 is cleaned by a belt cleaner 35 after the transfer material P is separated therefrom.

Descriptions are given below of the process cartridge 20 and toner cartridge 502 in the image-forming apparatus 102. It is to be noted that the process cartridges 20Y, 20C, 20M, and 20BK have nearly the same configuration, and the toner cartridges 502Y, 502C, 502M, and 502BK also have nearly the same configuration. Accordingly, in the following descriptions and in the figures, suffixes Y, C, M, BK showing each color in the process cartridge and toner cartridge are omitted. Similarly, the writing devices 20A to 20D have a similar configuration, so the suffixes A to D of reference numerals are omitted for simplicity.

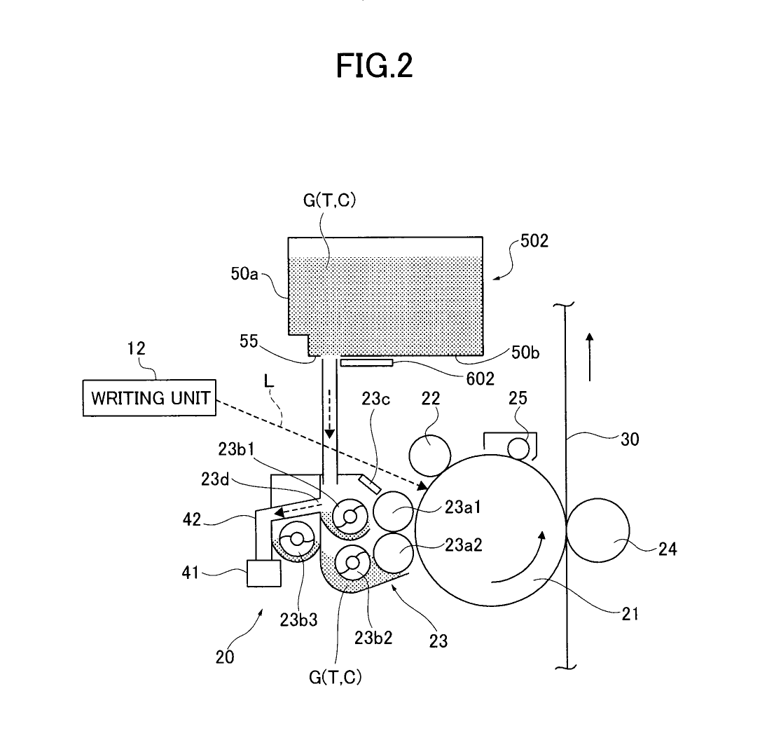

As shown in FIG. 2, each process cartridge 20 includes integrally the photoreceptor drum 21, a charged portion 22, the developing device 23, a cleaning unit 25, and the like. The process cartridge 20 employs a premix developing method in which carrier is supplied and discharged as required.

The photoreceptor drum 21 as the image bearer can be a negatively-charged organic photoreceptor and rotates in a counterclockwise direction by a not-shown driving unit. The charged portion 22 is an elastic charging roller which is formed by covering a metal core with an elastic layer of moderate resistivity, such as a foamed urethane layer that includes carbon black as electroconductive particles, a sulfuration agent, foaming agent, and the like. The material of the elastic layer of moderate resistivity in the charged portion 22 includes rubber such as urethane, ethylene-propylene diene monomer (EPDM), acrylonitrile butadiene rubber (NBR), silicone rubber, and isoprene rubber to which an electroconductive material such as carbon black or metal oxide is added to adjust the resistivity. Alternatively, foamed rubber including these materials may be used. The cleaning unit 25 includes a cleaning blush (or a cleaning blade) which contacts the surface of the photoreceptor drum 21 and scratches the surface. The cleaning unit 25 mechanically removes and collects untransferred toner on the photoreceptor drum 21.

The developing device 23 includes developing rollers 23a1 and 23a2 as developer bearers. The developing rollers 23a1 and 23a2 are disposed adjacent to the photoreceptor drums 21. A developing range in which magnetic brushes contact the photoreceptor drum 21 is formed at positions facing the developing rollers 23a1 and 23a2. The developing device 23 contains developer G (two-component developer) including toner T and carrier C. The developing device 23 develops the latent image formed on the photoreceptor drum 21 (toner image is formed). The detailed description of the configuration and operation of the developing device 23 will be given later.

The developing device 23 in Embodiment is a premix developing type, and fresh carrier C (developer G) is supplied thereto from the toner cartridge 502 as required. Degraded developer G is discharged to a developer storage 41 disposed outside the developing device 23. The toner cartridge 502 contains premixed developer G including toner T (toner particles) and carrier C (carrier particles) to be supplied to the developing device 23. The toner cartridge 502 contains developer G (toner T and carrier C) inside thereof. Developer G is supplied to the developing device 23. The toner cartridge 502 functions as a supply device to supply fresh toner T to the developing device 23 as well as to supply fresh carrier C to the developing device 23. In Embodiment, the ratio of toner T relative to carrier C in the developer G which is housed in the toner cartridge 502 (toner consistency) is high.

Next, an image formation operation on the photoreceptor drum 21 is described below.

As the photoreceptor drum 21 rotates counterclockwise, the surface of the photoreceptor drum 21 is charged at the charged portion 22 uniformly. Subsequently, the charged portion 22 of the photoreceptor drum 21 reaches the portion receiving the exposure light L, and an exposure process is carried on by a writing unit 12. Specifically, the surface of the photoreceptor drum 21 is discharged (electrical potential is changed) with the exposure light L selectively according to image data; thus, an electrostatic latent image is formed due to the differences in electrical potential (potential contrast) between the discharged portion and non-image portions that are not irradiated. In the exposure process, an electric charge-generating substance in a photosensitive layer of the photoreceptor drum 21 generates electrical charges upon receiving the light, and holes among them counteract with the charge potential on the surface of the photoreceptor drum 21.

Subsequently, the surface of the photoreceptor drum 21 where the latent image is formed reaches a position facing the developing device 23. The electrostatic latent image on the photoreceptor drum 21 comes into contact with the magnetic brushes formed on the developing rollers 23a1 and 23a2. The electrostatic latent image is adhered by the negatively-charged toner T in the magnetic brushes, and becomes visible. Specifically, the amount of developer G attracted by the magnetic force of the magnetic pole of the upper developing roller 23a is adjusted by a doctor blade 23c, and the developer G is transported to a developing range facing the photoreceptor drum 21 (facing position of developing rollers 23a1, 23a2 and photoreceptor drum 21). In the developing range, bristled carrier C scratches the surface of the photoreceptor drum 21. At that time, toner T contained in carrier C is charged negatively by friction with carrier C. On the contrary, carrier C is charged positively. The developing rollers 23a1 and 23a2 receive a predetermined developing bias from a not-shown power source. Thus, an electrical field is formed between the photoreceptor drum 21 and the developing rollers 23a1 and 23a2. Toner T is negatively charged and selectively adhered to the image portion (electrostatic latent image) on the photoreceptor drum 21 through the electrical field.

Thus, the toner image formed on the photoreceptor drum 21 reaches the position facing the transfer belt 30 and the transfer roller 24. At that time, the toner image on the photoreceptor drum 21 is transferred to the surface of the transfer material P transported to the position facing the transfer belt 30, timely. Herein, a predetermined voltage is applied to the transfer roller 24.

The transfer material P in which the toner image is transferred passes through the fixing device 36 and is discharged by a discharge roller 39 disposed outside the image-forming apparatus. Toner T remaining on the photoreceptor drum 21 (untransferred toner), which is not transferred to the transfer material P during the transfer process, reaches a position facing the cleaning unit 25 adhering to the photoreceptor drum 21. The untransferred toner on the photoreceptor drum 21 is collected and removed by the cleaning unit 25. Subsequently, the surface of the photoreceptor drum 21 passes through a not-shown discharge device and the residual potential thereon is removed.

The configuration and operation of the developing device 23 will be described hereinafter. The developing device 23 includes the developing rollers 23a1 and 23a2, screw conveyors 23b1 to 23b3 (auger screw), the doctor blade 23c, and the like. The two developing rollers 23a1 and 23a2 are configured to have a cylindrical sleeve configured by a non-magnetic material such as aluminum, brass, stainless steel, or conductive resin. The cylindrical sleeve can rotate in a clockwise direction through a not-shown driving unit. Inside the sleeve of the developing rollers 23a1 and 23a2, magnets to cause a magnetic field are attached so that developer G can be bristled on the circumferential surface of the sleeve. Carrier C in developer G bristles in a chain form on the sleeve along the magnetic line in a normal direction generated from the magnet. Electrically charged toner T is adhered to carrier C of the bristled chain, and a magnetic brush is formed thereby. The magnetic brush is transported in the same direction as the sleeves (clockwise direction) by the rotation of the sleeves.

The doctor blade 23c is disposed upstream of the developing range and controls the amount of developer G carried on (lift-up magnetically) the developing roller 23a1. The doctor blade 23c is a plate having a thickness of about 2 mm constructed by non-magnetic metallic material such as SUS316 and XM7. Alternatively, a thin metal sheet having a thickness of about 0.3 mm and constructed by SUS430 as the non-magnetic metallic material can be used on a surface facing the doctor blade 23c.

Three screw conveyors 23b1 to 23b3 are provided on a shaft part of the container as spiral screw portions. The screw conveyors 23b1 to 23b3 stir and merge developer G contained in the developing device 23 by circulating them in a longitudinal direction (vertically to the plane paper-surface of FIG. 2). The first screw conveyor 23b1 is provided in a position facing the developing roller 23a1, transports developer G in a horizontal direction (vertically to the plane paper-surface of FIG. 2), and supplies developer G on the developing roller 23a1. In other words, the first screw conveyor 23b1 faces the developing roller 23a1 and supplies developer G to the developing roller 23a1 by transporting developer G in the longitudinal direction (vertically to the plane paper-surface of FIG. 2).

The second screw conveyor 23b2 is provided at a position facing the developing roller 23a2 and on the lower portion of the first screw conveyor 23b1. The second screw conveyor 23b2 transports developer G which is separated from the developing roller 23a2 in a horizontal direction. Developer G is forcibly separated from the developing roller 23a2 through a developer-discharging rod after the developing process. In other words, the second screw conveyor 23b2 is provided at a position facing the developing roller 23a2 and transports developer G which is separated from the developing roller 23a2 in the longitudinal direction. The developer-discharging rod is formed by removing the magnetic pole partially from the magnet inside the sleeve, or by using a magnet having an arrangement in which a reactive magnetic field is generated. The first screw conveyor 23b1 and the second screw conveyor 23b2 are provided so as to keep the rotation axis to be approximately horizontal, similar to the developing rollers 23a1 and 23a2 or the photoreceptor drum 21.

Although not shown clearly in FIGS., the third screw conveyor 23b3 is provided obliquely to the horizontal direction so as to connect a downstream side of a transporting path corresponding to the second screw conveyor 23b2 with an upstream side of the transporting path corresponding to the first screw conveyor 23b1 linearly. The third screw conveyor 23b3 transports developer G transported by the second screw conveyor 23b2 towards the upstream side of the transporting path corresponding to the first screw conveyor 23b1. In addition, the third screw conveyor 23b3 transports developer G, circulated from the downstream side of the transporting path corresponding to the first developing screw 23b1 through a drop path, towards the upstream side of the transporting path corresponding to the first screw conveyor 23b1.

The transporting paths of the first screw conveyor 23b1, the second screw conveyor 23b2, and the third screw conveyor 23b3 are partitioned by wall sections. Although not shown in FIGS., the downstream part of the transporting path of the second screw conveyor 23b2 and the upstream part of the transporting path of the third screw conveyor 23b3 are connected through a first relay portion. The downstream part of the transporting path of the third screw conveyor 23b3 and the upstream part of the first screw conveyor 23b1 are connected through a second relay portion. The downstream portion of the first screw conveyor 23b1 and the upstream portion of the third screw conveyor 23b3 are connected through the drop path. By such a configuration, the three screw conveyors 23b1 to 23b3 can form a circulating path in which developer G circulates in a longitudinal direction.

A discharge outlet 23d (discharging device) is provided on a wall section of the transporting path of the first screw conveyor 23b1 for discharging a part of developer G contained in the developing device 23 to the outer part (developer storage 41). In detail, when developer G is increased to over the predetermined developer-amount in the developing device 23, and the upper surface of contained developer G exceeds the predetermined height, surplus developer G is discharged from the discharge outlet 23d towards the developer storage 41. That is, when the surplus developer G is higher than the height of the lower part of the discharge outlet 23d, it is discharged from the discharge outlet 23d, passes through a discharge path 42 and is dropped towards the developer storage 41 by gravity. Therefore, the carrier C, which is degraded by the pollution of a base resin of toner T or an external additive, can be discharged automatically from the discharge outlet 23d towards the outside of the developing range. The degradation in image quality can be prevented as well as aging degradation. Although not shown in FIG. 2, in the discharge path 42, the discharging rod is provided so as to transport developer which is discharged from the discharge outlet 23d to the horizontal direction.

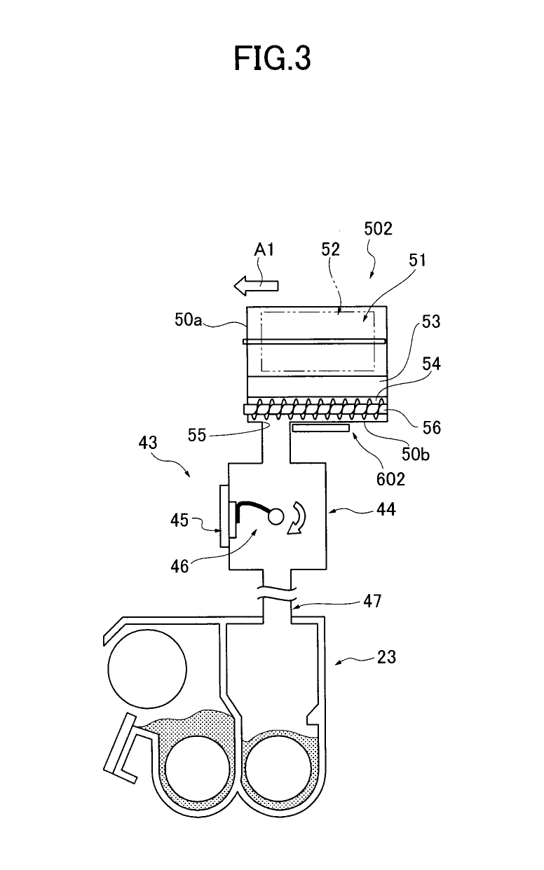

Descriptions are given below of the toner-supply device 43 (powder-particle supplier) which supplies fresh carrier C from the toner cartridge 502 to the developing device 23. FIG. 3 schematically illustrates the toner cartridge 502 in the case it is inserted into the toner-supply device 43 and its peripheral configuration.

As shown in FIG. 3, a container portion 51, stirring member 52, tapered portion 53, discharge path 54, discharge outlet 55, screw conveyor 56, and a shutter assembly 602 are included in the toner cartridge 502. The stirring member 52 is disposed to be rotatable on an inner side of the container portion 51. Although not shown in FIGS., the stirring member 52 stirs developer G housed in the container portion 51 (as shown in FIG. 2) through the appropriate rotation, and transports developer G to the tapered portion 53 by gravity. The tapered portion 53 is provided on the bottom surface side of the container portion 51 (opposite direction to the direction Y). The size of the tapered portion 53 gradually decreases from the inside towards the outside direction of the container portion 51. The discharge path 54 is formed on the fore end side of the tapered portion 53 (lower side of FIG. 3 as viewed from the front side), and placed sequentially to the tapered portion 53 while the bottom surface of the container portion 51 is opened. The discharge outlet 55 is formed on one end of the discharge path 54 and having an aperture to discharge developer G housed in the container portion 51, that is, the toner cartridge 502. The screw conveyor 56 is disposed to be rotatable inside the discharge path 54 (not shown clearly in FIGS.), and transports developer G in the discharge path 54 towards the discharge outlet 55 side.

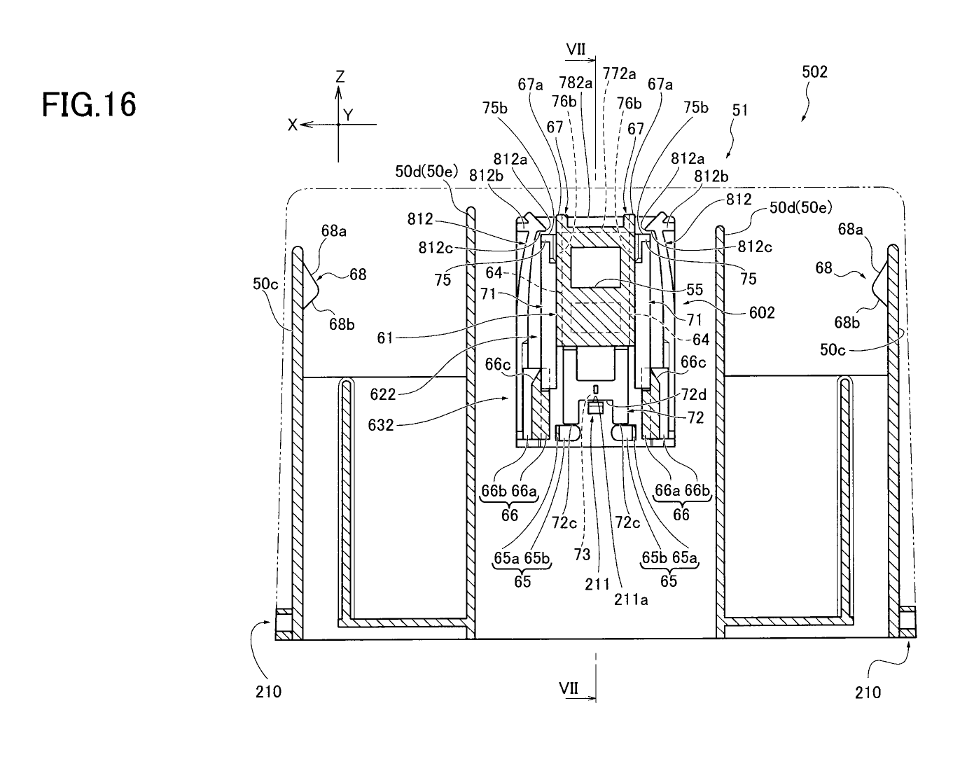

The shutter assembly 602 is provided so as to slide the bottom-side outer wall of the container portion 51 (toner cartridge 502). In a default position, the shutter assembly 602 faces and covers the discharge outlet 55 (refer to FIG. 16). The shutter assembly 602 slides the surface of the bottom-side wall section of the container portion 51 (toner cartridge 502), so as to open the discharge outlet 55 (refer to FIG. 3 and so on), when the toner cartridge 502 is inserted to the toner-supply device 43. The configuration and operation of the shutter assembly 602 will be described in detail later.

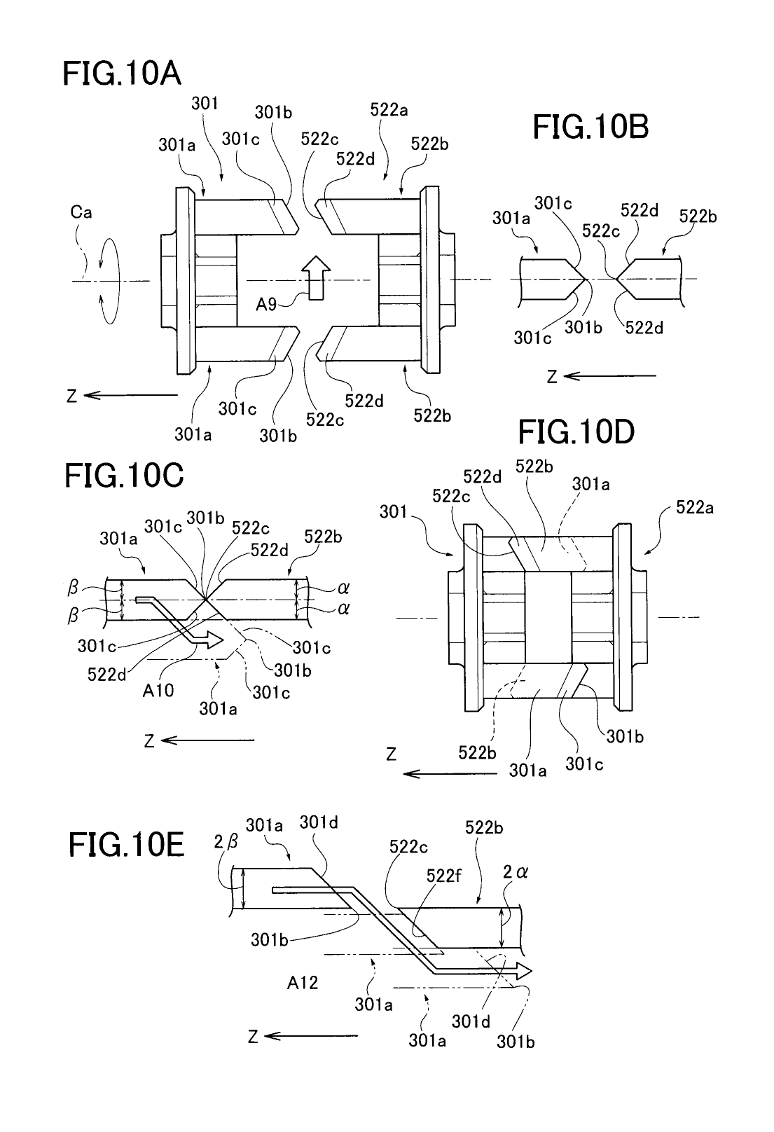

The toner cartridge 502 is inserted into the toner-supply device 43 by a slide-motion from the front side towards the internal side of the image-forming apparatus 102 (refer to arrow A1 in FIG. 3). At this time, the discharge outlet 55 opens through the slide-motion of the shutter assembly 602 on the back end surface of the container portion 51. Herein, although not shown in FIGS., each stirring member 52 and screw conveyor 56 is connected to a stirring-drive coupling (refer to numeral 301 in FIGS. 10A to 10E, later described) and a transporting-drive coupling provided with the toner-supply device 43. Then, in the container portion 51, developer G housed therein (not shown) is stirred by the stirring member 52 and moves to the tapered portion 53 which is provided on the bottom-surface side, by gravity. Subsequently, developer G is collected in the discharge path 54 adjacent to the tapered portion 53, and transported to the discharge outlet 55 through the rotation of the screw conveyor 56 provided with the discharge path 54. Thereby, developer G is discharged to the outer side through the discharge outlet 55, and reaches the toner-supply device 43.

A temporary toner chamber 44 is included in the toner-supply device 43. The developer G discharged from the discharge outlet 55 of the container portion 51 (toner cartridge 502) drops in the temporary toner chamber 44 by its own weight. A toner-detecting sensor 45 and a rotatable cleaning member 46 are provided with the temporary toner chamber 44. The toner-detecting sensor 45 is configured by a piezoelectric sensor and the like, and detects whether the temporary toner chamber 44 contains developer G or not. Although not clearly shown in FIGS., the rotatable cleaning member 46 is configured by a flexible cleaning member composed of a PET (polyethylene terephthalate) film and so on with the surface of a rotary shaft member. The rotatable cleaning member 46 cleans developer G which is adhered to a not-shown detecting surface of the toner-detecting sensor 45 via the rotation of the rotary-shaft member through a driver disposed in the toner supply device 43.

A toner transport tube 47 is connected to the bottom surface of the temporary toner chamber 44. Developer G which is delivered to the temporary toner chamber 44 is sent into the toner transport tube 47 by its own weight. The front end portion of toner transport tube 47 is connected to the developing device 23 in a process unit mounted in the printer body. Developer G in the toner transport tube 47 is sent toward the developing device 23 corresponding to a rotation of a not-shown rotatable transporting member such as a screw or an auger screw provided inside the toner transport tube 47. Thereby, developer G discharged from the toner cartridge 502 is supplied to the developing device 23.

A not-shown controller in the image-forming apparatus 102 estimates “toner-end” of the container portion 51 when the toner-detect signal is not sent from the toner-detecting sensor 45, even if the stirring member 52 and the screw conveyor 56 in the toner cartridge 502 are rotating. Herein, “inside the container portion 51” includes “inside the toner cartridge 502”, and “toner-end” means a condition in which almost all the contained developer G is used up. Even if the “toner-end” is detected, developer G still remains in the toner transport tube 47 actually, so developer G can be supplied for a while without refilling a new toner cartridge 502. As described, because the toner-end can be detected in the container portion 51 (toner cartridge 502) according to the amount of developer G in the temporary toner chamber 44, the timing of toner-end can be detected appropriately, without providing a toner-detecting sensor with the toner cartridge 502.

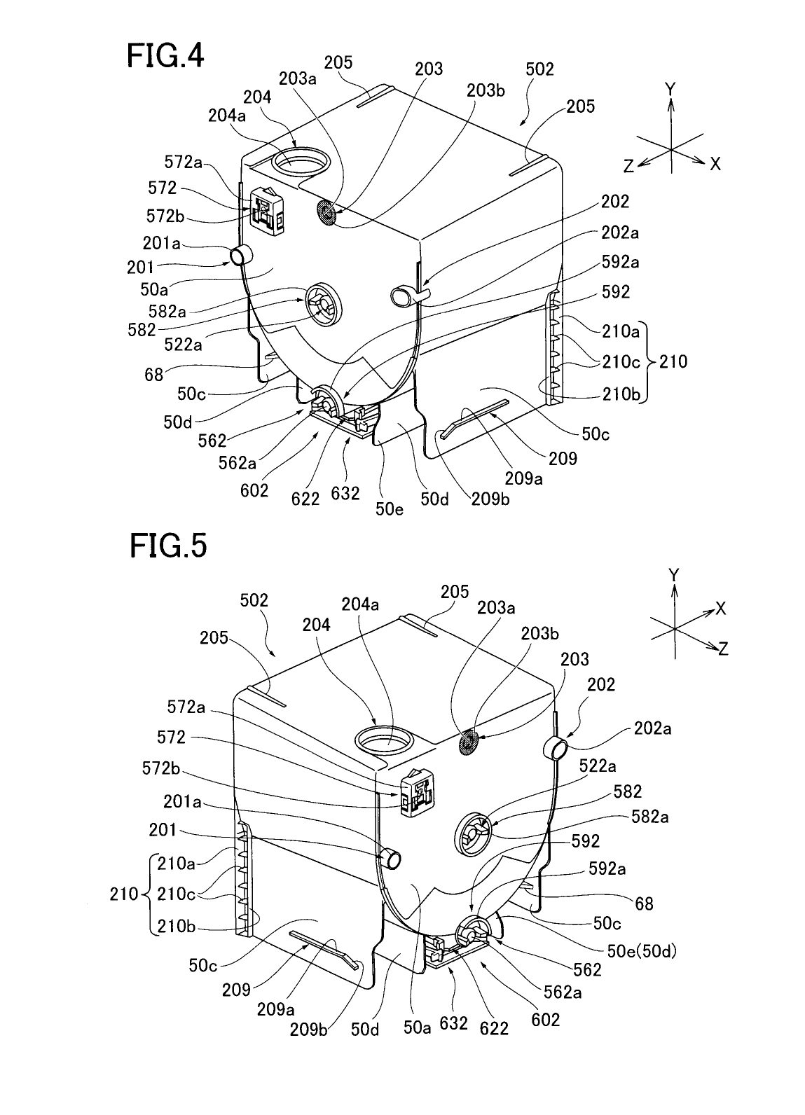

Descriptions are given below of the toner cartridge 502 (502Y, 502M, 502C, 502BK), the image-forming apparatus 102 accommodating the toner cartridge 502, and the toner-container fixing portion 902 in the image-forming apparatus 102 with reference to FIGS. 4 to 23.

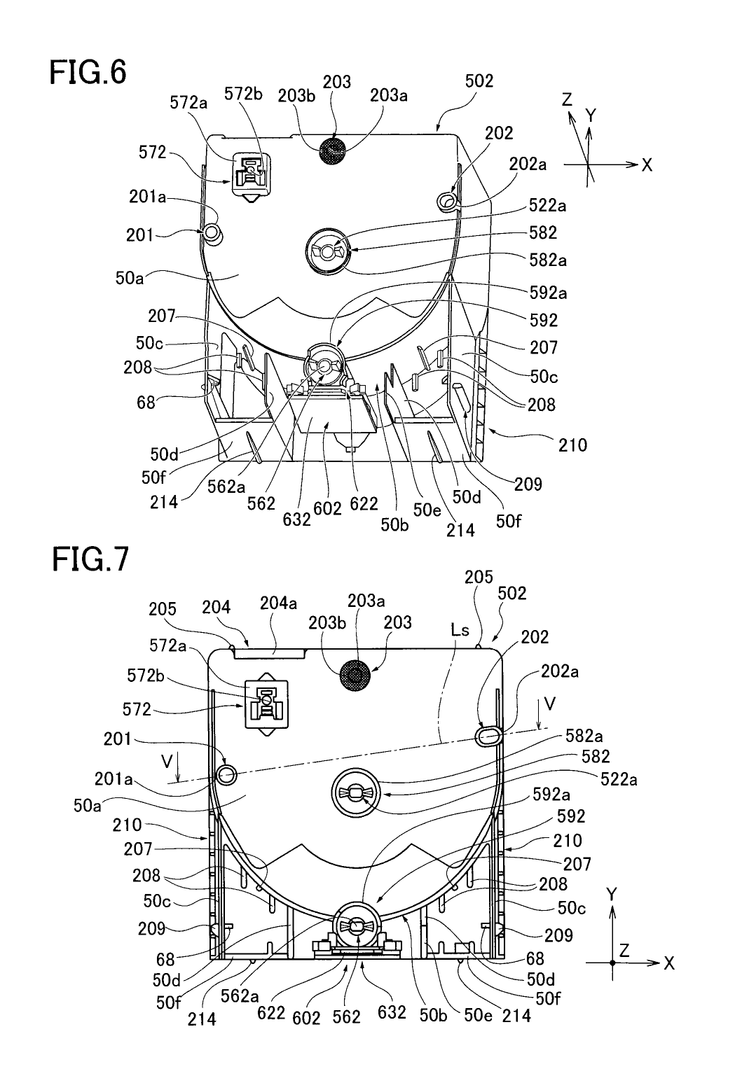

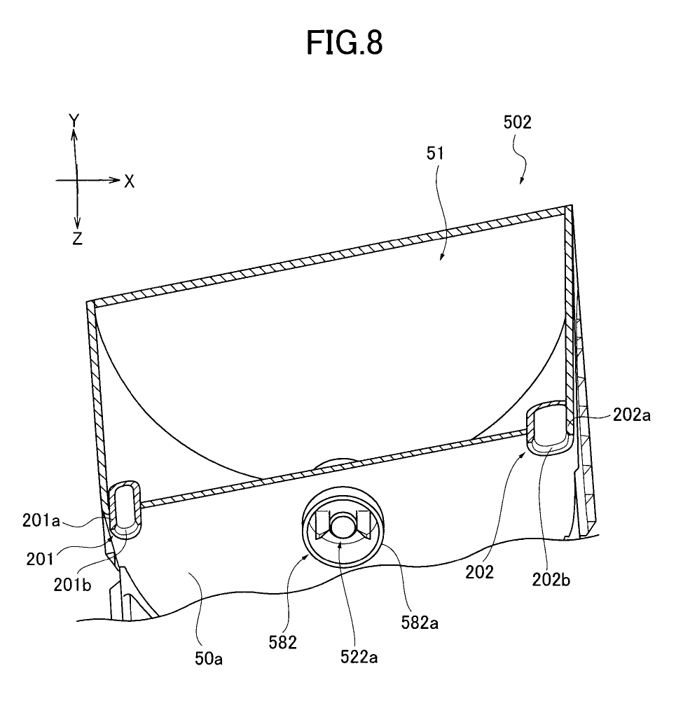

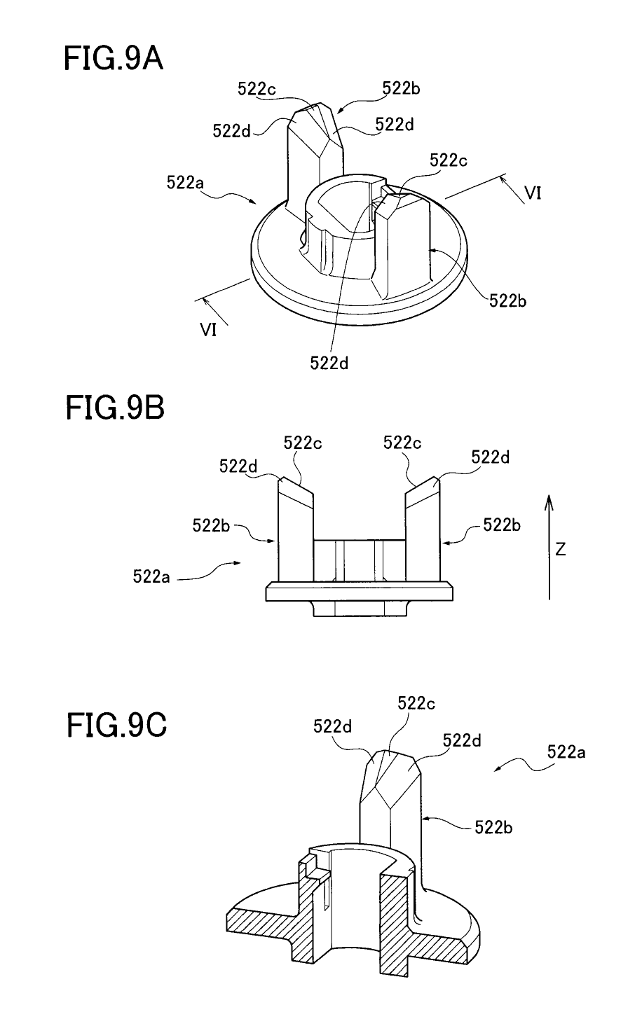

FIG. 4 is a perspective view of the toner cartridge 502 according to Embodiment as viewed from the top front side (direction Z). FIG. 5 is a perspective view of the toner-cartridge 502 as viewed from the top front side and from a different direction than that of FIG. 4 in the left and right direction. FIG. 6 is a perspective view of the toner cartridge 502 as viewed from the bottom front side (direction Z). FIG. 7 is a front view of the toner cartridge 502 as viewed from the front side. FIG. 8 is a perspective view of the toner cartridge 502 as viewed from the top front side, illustrating a partial cross-sectional view along the V-V line shown in FIG. 7 (direction Z surface including the V-V line section). FIGS. 9A to 9C are explanatory views illustrating a configuration of a coupling 522a in the stirring member 52 shown in FIG. 8. FIG. 9A is a perspective view showing the coupling 522a as viewed from the front side (direction Z). FIG. 9B is a side view of the coupling 522a (opposite to the direction Z). FIG. 9C is a cross-sectional view showing the coupling 522a along the VI-VI line shown in FIG. 9A.

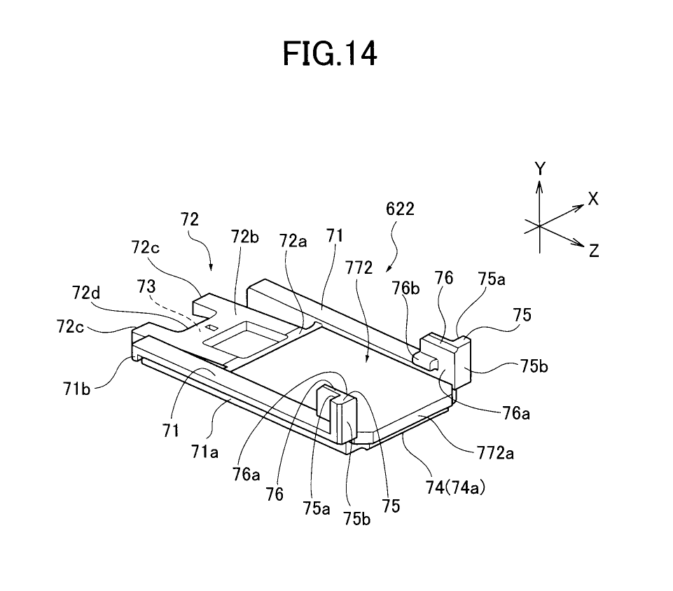

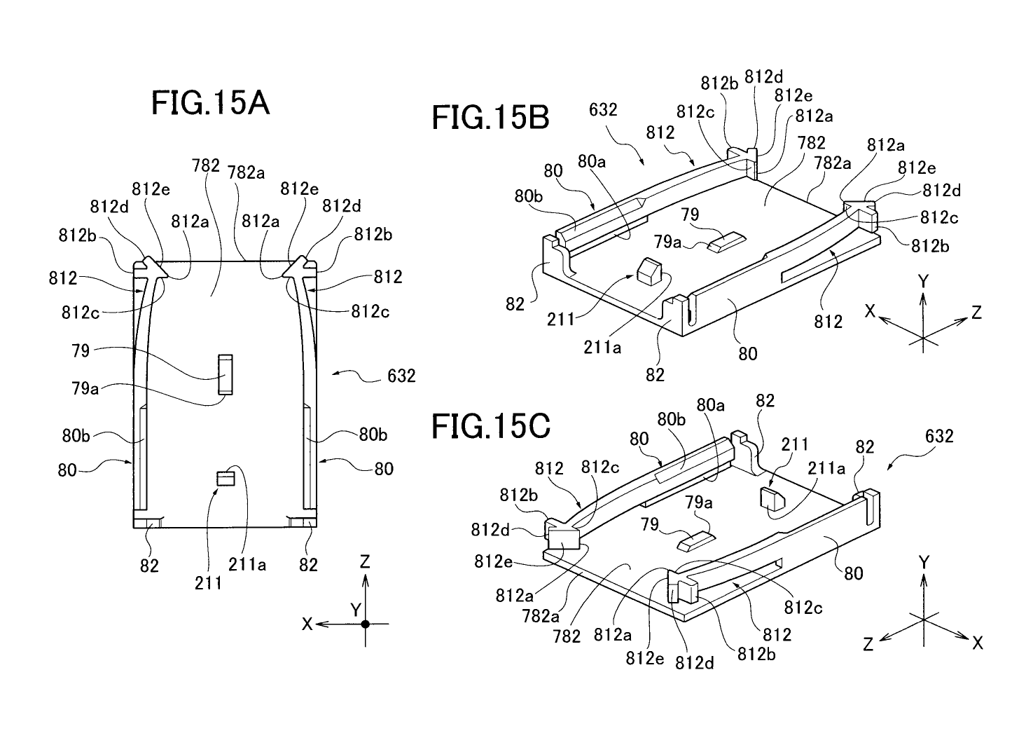

FIG. 14 is an explanatory view illustrating a configuration of a first shutter 622 provided in the shutter assembly 602 of the toner cartridge 502. FIGS. 15A to 15C are explanatory views illustrating a configuration of a second shutter 632 in the shutter assembly 602. FIG. 15A shows a front view of the second shutter 632 as viewed from the top side. FIG. 15B shows a perspective view of the second shutter 632 as viewed from the top side and the backward side of the inserting direction (opposite to the direction Z). FIG. 15C shows a perspective view of the second shutter 632 as viewed from the top side and the forward side of the inserting direction.

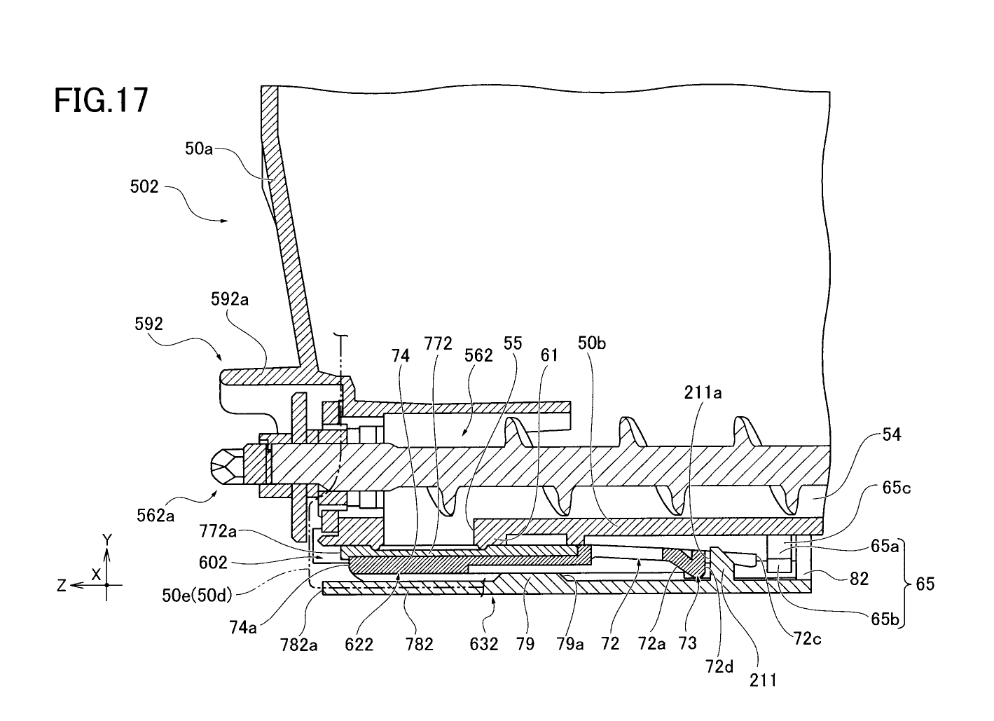

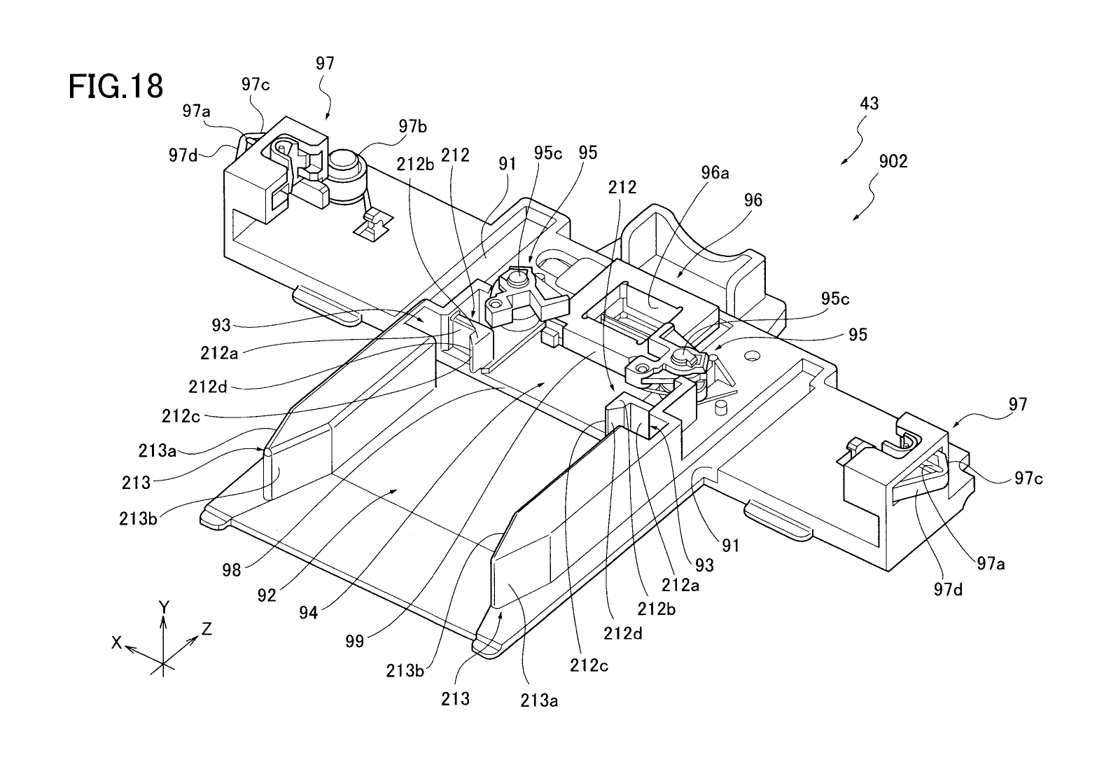

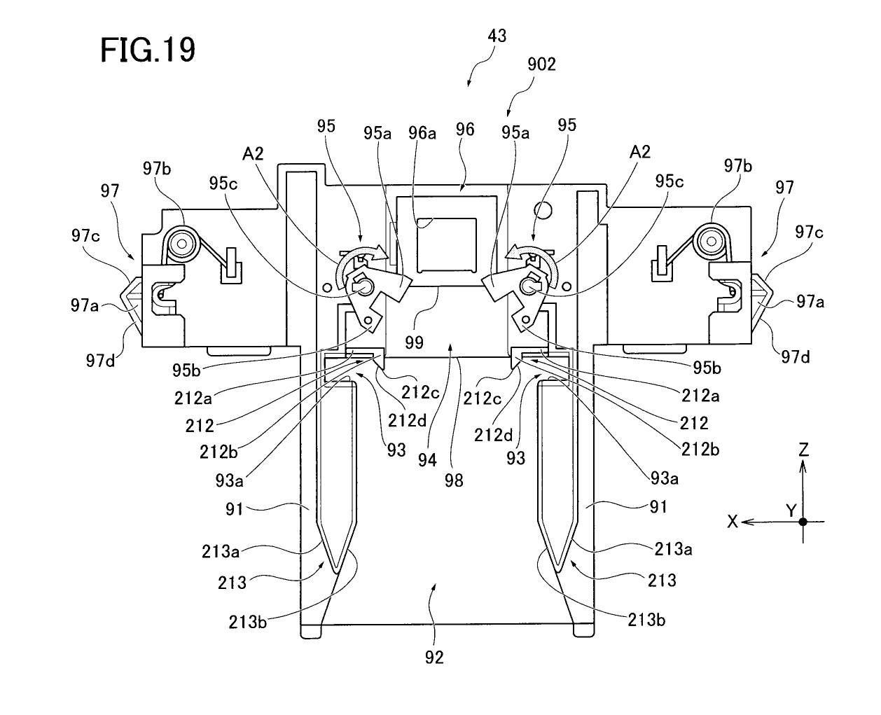

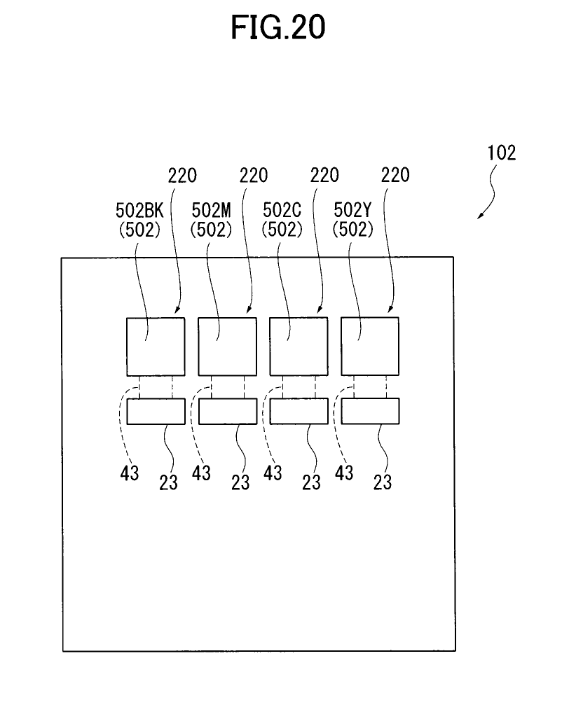

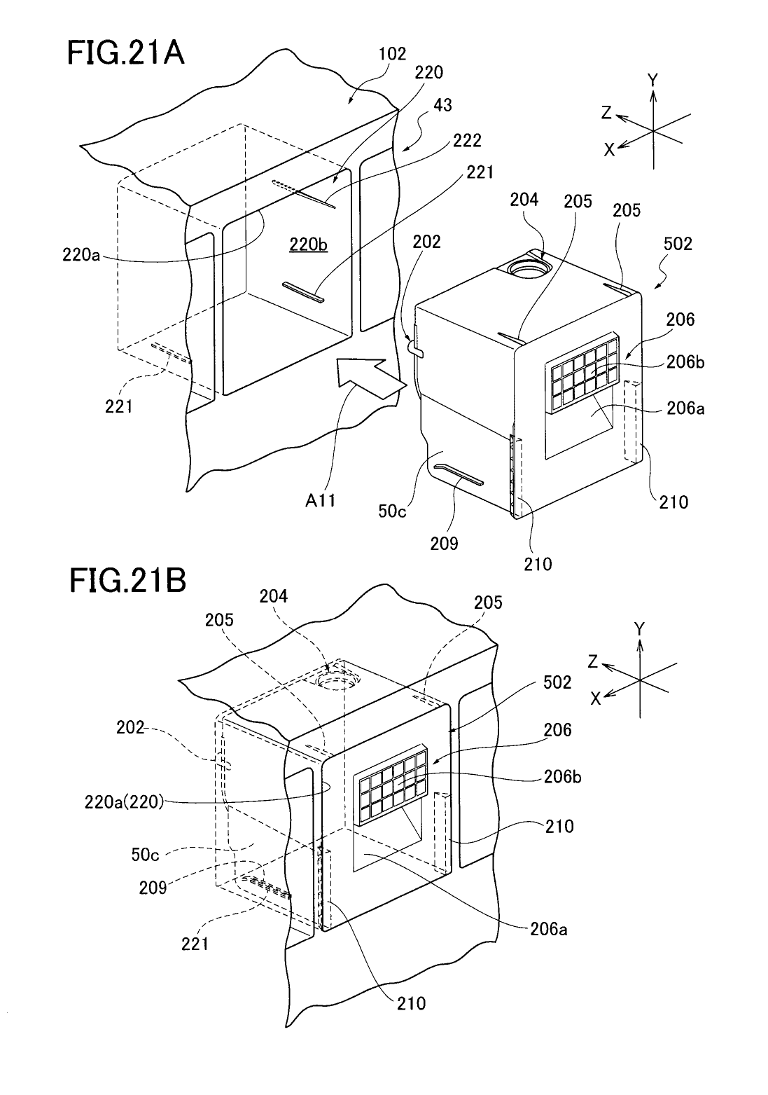

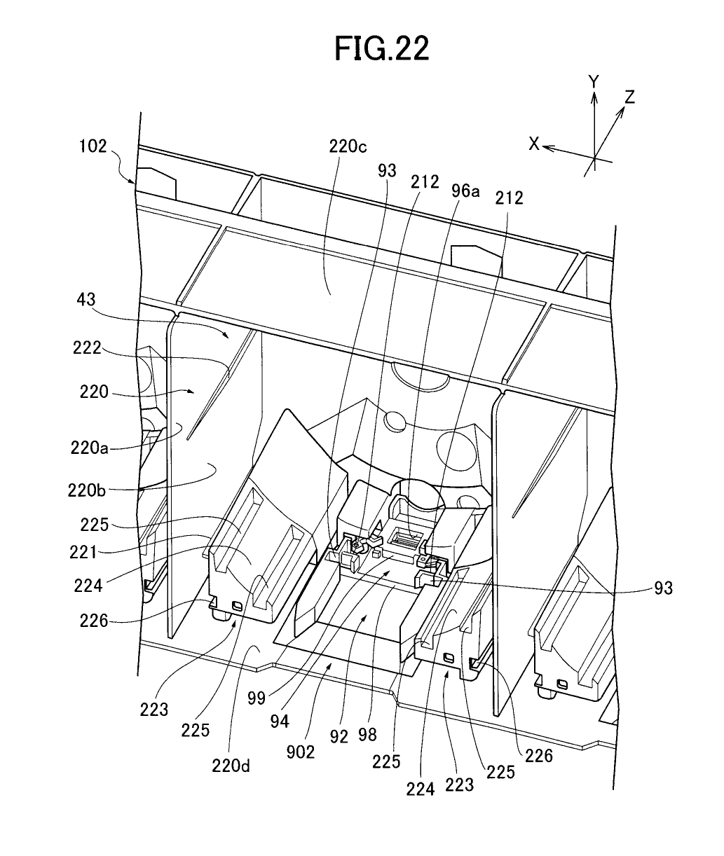

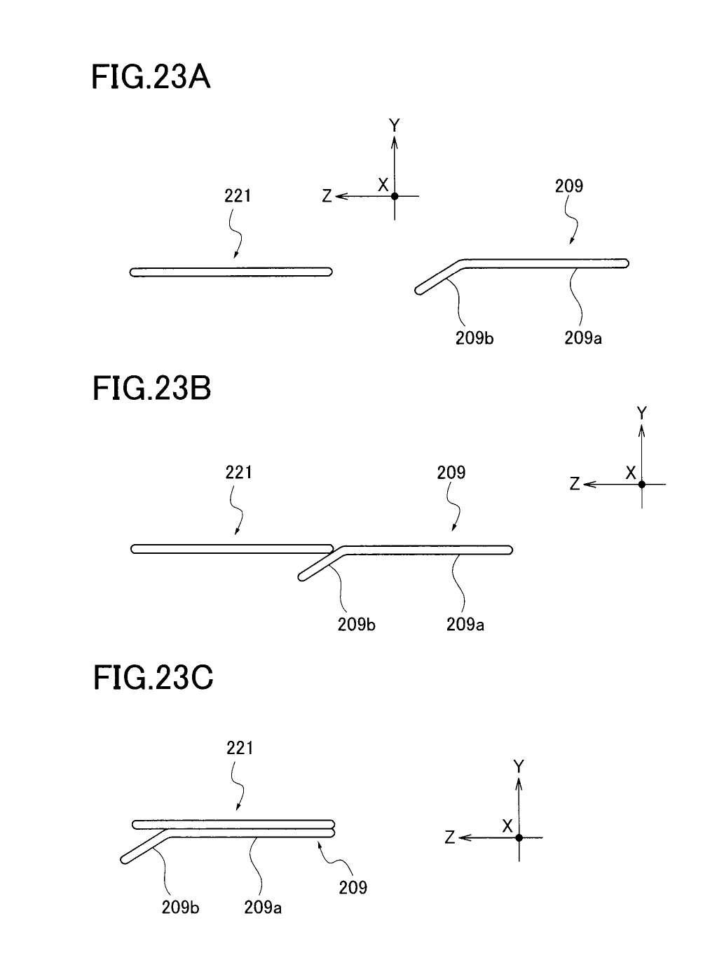

FIG. 16 is an explanatory view illustrating a configuration of the shutter assembly 602 comprised of the first shutter 622 and the second shutter 632 incorporated with the bottom surface of the container portion 51 (toner cartridge 502). FIG. 17 is an explanatory view of the container portion 51 shown in FIG. 3, illustrating a cross-sectional view along the VII-VII line (Y-Z plane including VII-VII line section). FIG. 18 is a perspective view of the toner-container fixing portion 902 of the toner-supply device 43. FIG. 19 is a front view of the toner-container fixing portion 902 as viewed from the top side (direction Y). FIG. 20 is an explanatory view schematically illustrating the image-forming apparatus 102. FIGS. 21A to 21B are explanatory views illustrating a relationship between the container mount 220 (toner-container fixing portion 902) of the image-forming apparatus 102 and the toner cartridge 502. FIG. 21A illustrates an aspect while inserting the toner cartridge 502 in the container mount 220. FIG. 21B illustrates an aspect in which the toner cartridge 502 is inserted into the container mount 220. FIG. 22 provides a perspective view illustrating a configuration of the container mount 220 (toner-container fixing portion 902). FIGS. 23A to 23C are explanatory views illustrating functions of a holding rail 209 in a side wall section 50c of the toner cartridge 502, and a holding rail 221 of the container mount 220. FIG. 23A illustrates an aspect in which the holding rail 209 faces the holding rail 221 in the Z-axis direction. FIG. 23B illustrates an aspect in which the holding rail 209 contacts the holding rail 221. FIG. 23C illustrates an aspect in which the holding rail 209 overlaps the holding rail 221 in the Y-axis direction.

In FIG. 8, an inner side configuration of the container portion 51 (toner cartridge 502) and the portions other than the coupling 522a in the stirring member 52 are omitted. FIG. 20 illustrates the developing device 23 in the image-forming apparatus 102, the toner-supply device 43, the container mount 220, and each toner cartridge 502 (502Y, 502M, 502C, 502BK) to be inserted in the container mount 220 in a simple manner. Configurations other than the above are omitted. In addition, in FIGS. 21A and 21B, to simplify description, each component in the container mount 220 and the toner-container fixing portion 902 is emphasized at the same time as being simplified, and does not always fit the actual configurations or the other FIGS.

As shown in FIGS. 4 to 8, the toner cartridge 502 has a box shape as a whole. The container portion 51 (refer to FIG. 8 and so on) is included in the toner-cartridge 502. In the toner-cartridge 502 (container portion 51, therein), an electronic substrate 572, a coupling aperture 582, a first positioning hole 201 and a second positioning hole 202, and a supply/exhaust port 203 are provided on the front end surface 50a (direction Z).

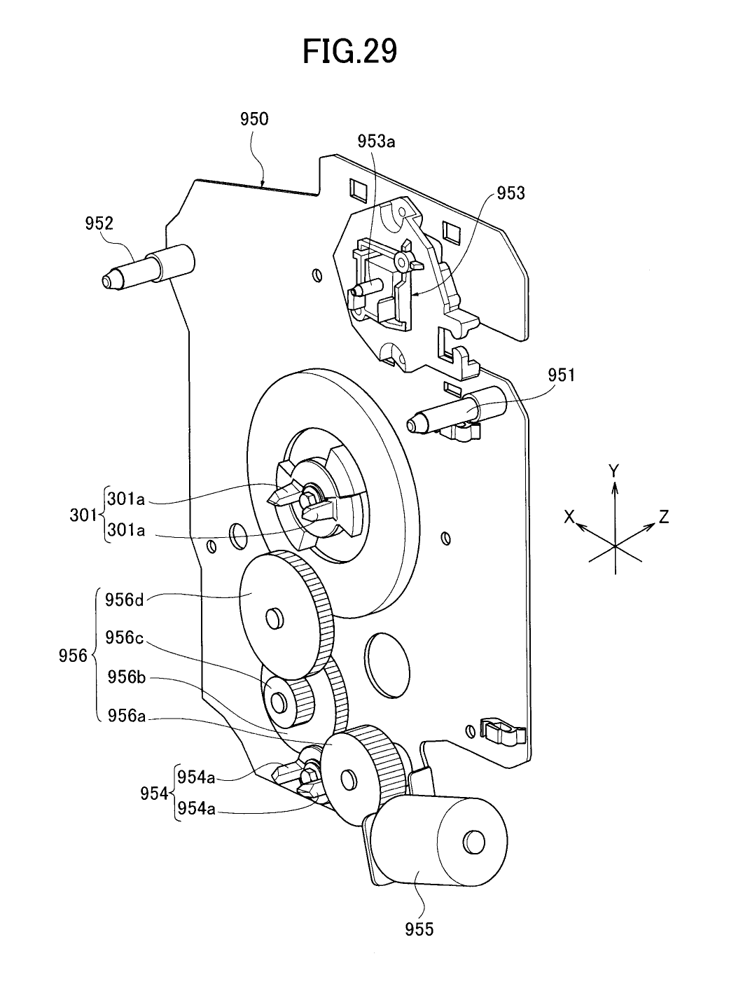

The outer side of the electronic substrate 572 is covered with a substrate cover 572a. The electric substrate 572 can move inside the substrate cover 572a along the X-Y plane surface. A position-adjustment hole 572b is formed in the center of the electric substrate 572. A position-adjustment protrusion provided in the later-described container mount 220 (refer to FIG. 22) can fit into the position-adjustment hole 572b in the Z-axis direction. The size of the position-adjustment hole 572b is arranged so as to fit the position-adjustment protrusion in a direction along the X-Y plane when the protrusion fits into the hole 572b. When the position-adjustment protrusion fits into the position-adjustment hole 572b, a position of a later-described communication substrate which is disposed in the container mount 220 of the toner-supply device 43 (refer to FIG. 22) locates on an appropriate position in the electric substrate 572. Such a position is appropriate herein because a contact terminal which is provided with the communication substrate is able to contact appropriately with the electric substrate 572 (contact terminal provided therein). Similarly, a condition in which a connection (data exchange) between the communication substrate and the electric substrate 572 can be established appropriately through both contact terminals is appropriate herein. Thus, the information exchange via a connection can be achieved between the electric substrate 572 and the image-forming apparatus 102 (refer to FIG. 20, and so on) including the controller, through the communication substrate disposed in the toner-supply device 43, when the position-adjustment protrusion fits into the position-adjustment hole 572b. The position-adjustment protrusion is provided in relation to the position of a first positioning pin 951 (refer to FIG. 29) which is provided corresponding to the position of the first positioning hole 201 as a basic position, in the toner-supply device 43. When the toner cartridge 502 is inserted appropriately into the toner-supply device 43, the electrical substrate 572 locates the appropriate position. Thus, the electric substrate 572 (and position-adjustment hole 572b thereof) is provided with the toner-cartridge 502 (front end surface 50a thereof, direction Z) in the position corresponding to the first positioning hole 201 as standard.

The coupling 522a of the stirring member 52 provided inside the container portion 51 exteriorizes towards the front side (direction Z) of the container portion 51 through the coupling aperture 582. The configuration of the coupling 522a will be described in detail later. A guard wall section 582a is provided with the coupling aperture 582 surrounding the aperture in which the coupling 522a can be exteriorized. The guard wall section 582a is formed so as to protrude from the front surface of the toner cartridge 502 (container portion 51) towards the forward side in the direction Z. The guard wall section 582a surrounds the coupling 522a which exteriorizes from the coupling aperture 582 in the perpendicular direction to the Z-axis. Thus, the coupling aperture 582 can be prevented from contacting with the coupling 522a in the opposite direction to the direction Z by the guard wall section 582a. Therefore, the coupling 522a can be protected. The coupling aperture 582 (including coupling 522a of the stirring member 52) is arranged in the toner cartridge 502 (front end surface 50a, direction Z) according to the position of the first positioning hole 201 as the normal position.

The first positioning hole 201 is formed inside a first positioning-wall section 201a which has a cylindrical shape which extends in the direction Z in the front surface of the toner cartridge 502 (container portion 51). The first positioning-wall section 201a protrudes towards the direction Z from a front wall section which forms the front surface of the toner cartridge 502 (container portion 51), and protrudes from the front wall section (inner side of container portion 51) towards the opposite side of the direction Z, as shown in FIG. 8. The inside space of the first positioning-wall section 201a extending in the Z-axis direction is formed in a circle when viewing the cross-sectional surface from the opposite side of the direction Z (refer to FIG. 7). Therefore, the first positioning hole 201 is formed in a circle when viewing its cross-sectional surface from a perpendicular direction of the direction Z. The first positioning hole 201 extends in the direction Z.

The first positioning-wall section 201a contacts the internal side surface of the container portion 51 (that is, inside container portion 51 of toner cartridge 502). The overall section in the direction Z of the first positioning-wall section 201a which is inside the container portion 51 contacts the internal side surface of the toner cartridge 502 (container portion 51). In addition, an inclination-surface section 201b is provided on an end part of the first positioning-wall section 201a in the direction Z. The inclination-surface section 201b inclines so that the internal space, that is, the inner diameter of the first positioning hole 201 gradually becomes larger towards the direction Z.

The later-described first positioning pin 951 (refer to FIG. 29) provided with the container mount 220 (refer to FIG. 22) in the toner-supply device 43 can fit into the first positioning hole 201 in the direction Z. The first positioning pin 951 has a column shape extending in the direction Z. The size of the first positioning pin 951 is arranged so as to fit into the first positioning hole 201 in the direction along the X-Y plane upon insertion. Thereby, the direction of the toner cartridge 502 can match the direction Z of the toner-supply device 43 (later-described container mount 220 as shown in FIG. 22) by fitting the first positioning pin 951 into the first positioning hole 201. Because the inclination surface section 201b is provided on the front end portion of the first positioning hole 201 in the direction Z, it is easy to fit the first positioning pin 951 when the toner cartridge 502 is inserted into the later-described container mount 220 (toner-supply unit 43).

The second positioning hole 202 is formed inside a second positioning-wall section 202a which has a column-shape and extending in the direction Z on the front surface of the toner-cartridge 502 (container portion 51), as shown in FIGS. 4 to 8. The second positioning hole 202 is provided on the opposite side to the first positioning wall section 201a of the first positioning hole 201 in the left and right direction. As shown in FIG. 8, the second positioning-wall section 202a protrudes from the front wall section of the toner cartridge 502 (container portion 51) towards the forward side in the direction Z, and protrudes from the front wall section towards the opposite direction to the direction Z. In the inner space P extending to the direction Z on the cross-sectional surface on the opposite side of the direction Z, a direction of the line LS, which connects the central position thereof and the central position of the first positioning wall section 201a, is longer. That is, the second positioning-wall section 202a has a semicircular portion on each side in the direction of the line LS, and the second positioning wall section has a longer hole in the line LS direction. That is, the second positioning hole 202 has a longer hole in the direction of line LS when the cross-sectional surface thereof in the perpendicular direction to the Z-axis is viewed.

The second positioning wall section 202a contacts the internal side surface of the container portion 51 (that is, the toner cartridge 502) on the opposite side of the first positioning wall section 201a in the left and right direction. In the second positioning wall section 202a, the overall section in the direction Z inside the container portion 51 contacts the inside surface of the toner cartridge 502 (container portion 51). In addition, an inclination wall section 202b is provided with the second positioning wall section 202a on an end portion thereof in the direction Z. The inclination wall section 202b is arranged so as to expand the internal space thereof, in other words, an inner diameter of the second positioning hole 202 becomes larger towards the direction Z.

A second position-detecting pin 952 (refer to FIG. 29) which is provided with the later-described container mount 220 (refer to FIG. 22) in the toner supply device 43 can fit into the second positioning hole 202. The second position-detecting pin 952 has a column-shape having longer length in the direction Z. The second position-detecting pin 952 has a size so as to fit into the second positioning hole 202 along the X-Y surface and the perpendicular to the line LS (refer to FIG. 7) when inserting. In other words, the second position-detecting pin 952 is arranged so as to be inserted towards the line LS direction (refer to FIG. 7) in the second positioning hole 202 when fitting into the second positioning hole 202. The second positioning hole 202 can accept the second position-detecting pin 952 by adjusting the differences of the gap between the first positioning hole 201 and the second positioning hole 202 corresponding to the gap between the first positioning pin 951 and the second positioning pin 952 in the container mount 220 (refer to FIG. 22). Thereby, the first positioning pin 951 can fit into the first positioning hole 201, and the second positioning pin 952 can fit into the second positioning hole 202. From such a configuration, the toner cartridge 502 can keep a predetermined attitude in relation to the toner-supply device 43 (later-described container mount 220 as shown in FIG. 22). The second positioning hole 202 can accept the second position-detecting pin 952 more easily when the toner cartridge 502 is inserted into the later-described container mount 220 (toner-supply device 43) because the inclination surface portion 202b is provided on the front end part thereof in the direction Z.

Herein, the configurations of the first positioning hole 201 and the second positioning hole 202 are arranged at least so that the toner cartridge 502 can keep the predetermined attitude to the container mount 220 (toner-supply device 43). That is, the configurations of the first and second positioning holes 201 and 202 can be different to each other, and not always limited to the configuration according to Embodiment. For example, they can be disposed in the opposite position to each other. The second positioning hole is not necessary to have a long hole.

A supply/exhaust port 203 is provided adjacent to the upper end (end portion in the direction Y) in the front surface of the toner cartridge 502 (container portion 51). The supply/exhaust port 203 includes a supply/exhaust pore 203a penetrating through the front wall portion of the toner cartridge 502 (container portion 51) and a filter 203b provided on the end portion thereof in the direction Z. The supply/exhaust pore 203a is provided with a portion which is not blocked by developer G, in other words, a position not buried in housed (supplied) developer G in the condition that developer G is fully contained in the toner cartridge 502 (shipping condition, for example). The position which is not blocked by developer G is such that the direction Y of the toner cartridge 502 faces the upper side vertical direction. The filter 203b accepts transmission of air while preventing developer G housed in the container portion 51 from escaping outside. In this regard, the supply/exhaust port 203 is configured so as to prevent developer G from escaping, and so as to supply air to the container portion 51, and to exhaust the air from the container portion 51. The supply/exhaust pore 203a (supply/exhaust port 203) can be provided at various positions as long as it is not blocked by developer G. For example, it can be provided on the upper surface of the toner cartridge 502, or another portion, and it is not limited to the configuration according to Embodiment.

A sealing/opening portion 592 is provided on the bottom part of the container portion 51 successively to a discharge path 54 (refer to FIG. 3). In the sealing/opening portion 592, a coupling 562a of a screw conveyor 56 provided rotatably in the transporting path 54 can be exposed from the front surface of the container portion 51 (front side surface in the Z-axis direction). The upper side of the sealing/opening portion 592 is shielded by a roof portion 592a. Herein, one side in the left and right direction of the roof portion 592a is cut out. Thereby, due to the roof portion 592a, the sealing/opening portion 592 can be prevented from contacting the coupling 562a of the screw conveyor 56 on the upper side in the opposite direction of the direction Z and on the other side in left and right direction. Therefore, the coupling 562a can be protected. The sealing/opening portion 592 (coupling 562a of screw conveyor 56 provided therein) is arranged in the toner cartridge 502 (in front end surface 50a indirection Z) at the position corresponding to that of the first positioning hole 201 as a standard.

The coupling 562a is configured to be similar to the coupling 522a of the stirring member 52. Therefore, hereinafter, only the configuration and operation of the coupling 522a are described, and those of the coupling 562a are omitted. The coupling 522a (coupling 562a) includes a pair of hook protrusions 522b, as shown in FIGS. 9A to 10E. The hook protrusions 522b are provided on each side of the shaft line of the stirring member 52 as a center axis. Each of the pair of hook protrusions 522b includes an inclination portion provided adjacent to an end portion 522c. Such inclinations are formed so as to reduce the length of the hook protrusions 522b on the opposite side of direction Z, from the surface of end portion 522c. A pair of inclination surfaces 522d is provided with the hook protrusions 522b on the end portion 522c side in a circumferential direction centering the shaft line of the stirring member 52. Both inclination surfaces 522d incline so as to reduce the length of the hook protrusions 522b (decrease in the opposite direction of direction Z) from the side of the end portion 522c towards the outer side.

The coupling 522a is connected to the stirring-drive coupling 301 (refer to FIG. 10D) provided in the container mount 220 in the toner-supply device 43. The stirring-drive coupling 301 is disposed in the container mount 220 (toner-supply device 43), and includes a similar configuration to the transporting-drive coupling in which the coupling 562a of the screw conveyor 56 is connected. As shown in FIG. 10A and similar to the coupling 522a, the stirring-drive coupling 301 includes a pair of hook protrusions 301a. The hook protrusions 301a are provided on each side of a central axis Ca of the stirring-drive coupling 301 (equivalent to the shaft line of the stirring member 52). The stirring-drive coupling 301 rotates around the central axis Ca in the container mount 220. Thus, the hook protrusions 301a are able to rotate around the central axis Ca by receiving the driving force from a rotary-drive unit. When the stirring-drive coupling 301 does not rotate in the container mount 220 (toner-supply unit 43), an allowance area exists within the stirring-drive coupling 301 in the rotational direction centering the axis Ca. Therefore, a slight rotation (transference by rotation of hook protrusions 301a) can be permitted through the stirring-drive coupling 301 by receiving an external force.

The hook protrusion 301a includes an inclination portion disposed adjacent to the end portion 301b on the upper side end of the direction Z. Such inclinations are formed so as to reduce the length of hook protrusions 301a, in the opposite direction to the direction Z. Thereby, each end portion 301b of a pair of hook protrusions 301a can be horizontal to each end portion 522c of a pair of hook protrusion 522b in a direction of the central axis Ca, when the central axis Ca fits the shaft line of the stirring member 52, and the stirring-drive coupling 301 faces the coupling 522a. In the above-described condition, a pair of the end portion 301b and the end portion 522c contact with each other when the stirring-drive coupling 301 approaches the coupling 522a. Herein, a guiding force is generated so as to guide a pair of hook protrusions 301a towards the inside a pair of hook protrusions 522b through the guiding function of two pairs of the end portions 301b and 522c. Therefore, the central axis Ca and the shaft line of the stirring member 52 can be prevented from mismatching between the stirring-drive coupling 301 and the coupling 522a, even if both of the hook protrusion 301a (end portion 301b) and hook protrusion 522b (end portion 522c) have contact with each other.

As shown in FIG. 10B, a pair of inclination surfaces 301c is provided on both sides centering the central axis Ca in the circumferential direction. A pair of inclination surfaces 301c inclines so as to reduce the length of the hook protrusion 301a from the end portion 301b in the direction Z. In Embodiment, the inclination angle of the inclination surfaces 301c is similar to that of the inclination surfaces 522d in the end portion 522c. Therefore, as described, when the central axis Ca fits the shaft line of the stirring member 52 and a pair of end portions 301b of the stirring-drive coupling 301, and each end portions 522c of the coupling 522a contact with each other (refer to FIGS. 10A to 10E), one of the inclination surface 301c as viewed from the circumferential direction of the end portion 301b contacts the other inclination surface 522d as viewed from the circumferential direction of the end portion 522c. Herein, the stirring-drive coupling 301 can rotate around the central axis Ca, as described. The stirring-drive coupling 301 rotates and moves closer to the coupling 522 through the guiding function of the inclination surfaces 301 and 522d (refer to arrow A10), and it can prevent knocking between the end portion 301b of the stirring-drive coupling and the end portion 522c of the coupling 522a. As shown in FIG. 10D, the stirring-drive coupling 301 and the coupling 522 are provided so that two pairs of hook protrusions 301a and 522b locate one after the other, as viewed from the circumferential direction (rotation direction) centering the central axis Ca. In this case, when the stirring-drive coupling 301 rotates in the container mount 220 (toner-supply device 43), the stirring member 52 of the toner cartridge 502 rotates through which the hook protrusion 301a pushes the corresponding hook protrusions 522b in the rotational direction. Therefore, the stirring-drive coupling 301 and coupling 522a are connected under the condition that the two pairs of hook protrusions 301a and 522b locate one after the other, as viewed from the circumferential direction (rotation direction) centering the central axis Ca as described.

As shown in FIGS. 4, 5, 11, and 12, a loading section 204 and a clamping piece 205 are provided on the upper surface of the toner cartridge 502 (positive side surface of the direction Y). The loading section 204 is configured to include a cap 204a on a loading port which penetrates the upper wall section defining the upper surface of the toner cartridge 502. The loading port is connected to the container portion 51. Developer G is loaded from the loading port toward the container portion 51 in the loading section 204. The cap 204a can prevent developer G from escaping by sealing the loading port of the loading section 204.

The clamping piece 205 is provided in a pair on the upper surface of the toner cartridge 502, adjacent to the rear side (negative direction to the direction Z) and adjacent to the outer side as viewed from the left and right direction (direction X). A pair of clamping pieces 205 protrudes from the upper surface of the toner cartridge 502 towards the positive side of Y-axis direction. The protruding portion in the positive side of Y-axis direction of the clamping piece 205 increases gradually towards the negative side of the Z-axis direction.

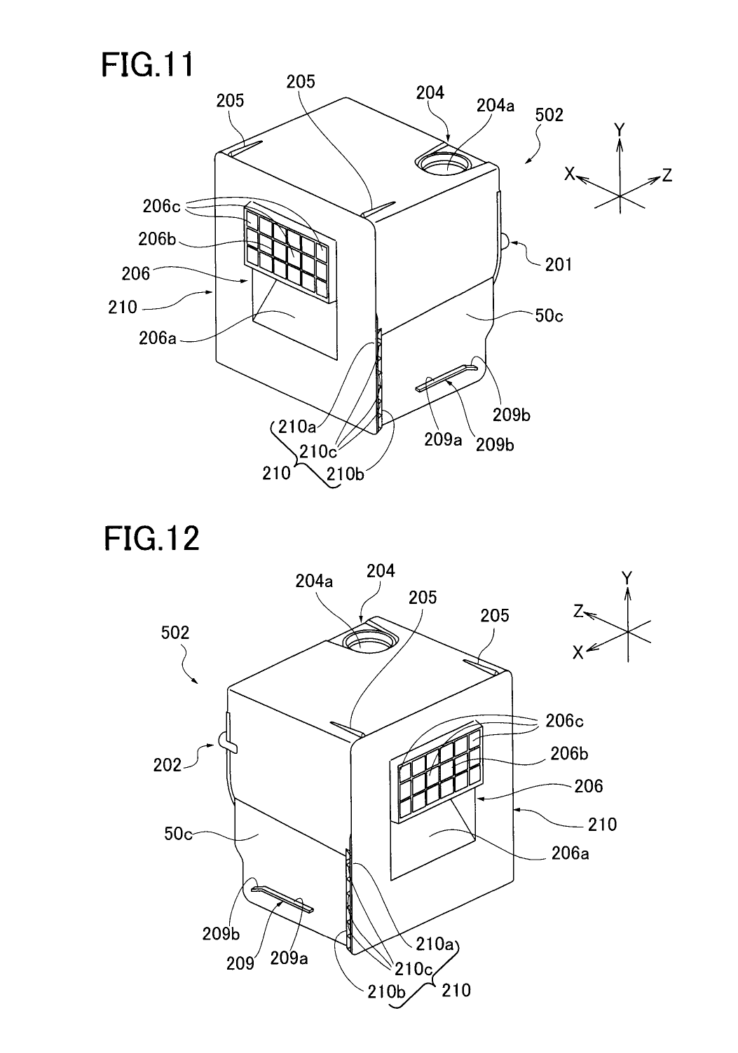

As shown in FIGS. 11 and 12, a handle 206 is provided on the rear surface of the toner cartridge 502 (negative side of the direction Z). The handle 206 includes a recess 206a and a handle wall section 206b covering the upper side of the recess 206a. The recess 206a is formed by putting a recessed portion partially on the center of a back wall section defining the back wall surface of the toner cartridge 502 so that the center part of the back wall section includes the recess 206a having a dent in the direction Y. The handle wall section 206b includes a grid-shape rib 206c so as to secure rigidity. The handle 206 makes it easier to carry the toner cartridge 502 by grabbing the handle wall 206b with hands inserted in the recess 206a.

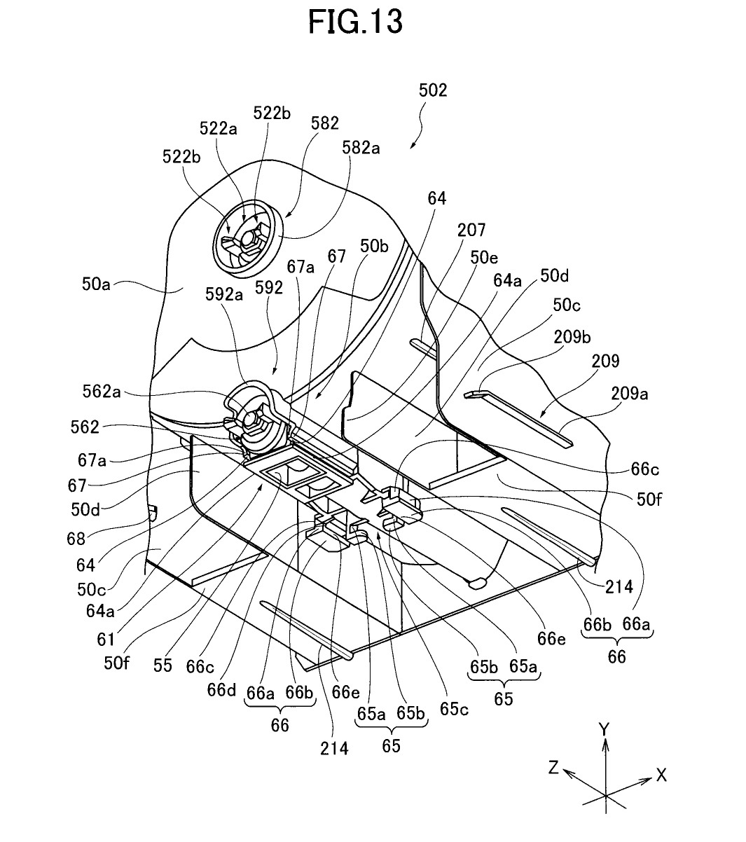

As shown in FIG. 13, an attachment mount 61 having a rectangle shape and partially protruding toward the negative direction to the direction Y is provided around the discharge outlet 55 in a lower wall section 50b of the toner cartridge 502. The shutter assembly 602 is configured by providing the first shutter 622 and the second shutter 632 with the attachment mount 61 so as to slide and move thereon in the direction Z (refer to FIG. 16). A pair of guiding recesses 64 is formed on the attachment mount 61. Each guiding recess 64 is formed by disposing recesses which have a dent in the direction X and extend in the direction Z (refer to FIG. 13) on both end sides of the attachment mount 61 in the direction X. A pair of pieces 64a protruding in the direction X relatively from the guiding recess 64 is formed with the arrangement of the guiding recess 64. In other words, the pieces 64a are provided so as to define the guiding recess 64 on the attachment mount 61.

A pair of fixing protrusions 65, a pair of support protrusions 66, and a pair of releasing protrusions 67 are provided on the lower wall section 50b in which the attachment mount 61 is provided. In addition, a connection plate portion 207 and a discrimination protrusion 208 are provided on the lower wall section 50b (refer to FIG. 7). The fixing protrusions 65 include a base end section 65a and a pressed portion 65b, and define a circulation space 65c between the lower wall section 50b and the pressed portion 65b. The support protrusions 66 include a base end section 66a and a flat plate 66b. An end portion of a pair of base end sections 66a corresponds to an inclination wall surface 66c. The support protrusions 66 include a protruding stopper 66d which is formed through which the end portion of the flat plate 66b in direction Z partially protrudes toward the direction Y. The releasing protrusions 67 are provided on the end portion in the direction Z of the attachment mount 61, and protrude towards the direction Z. Front end surfaces 67a of the releasing protrusions 67 in the direction Z are present on an identical plane to the X-Y plane. The releasing protrusions 67 are provided on the upper side of a pair of the guiding recesses 64 (direction Y) in the attachment mount 61.

As shown in FIGS. 6 and 7, the connection plate portion 207 protrudes from the lower wall section 50b toward a direction orthogonal to a curved surface defined by the lower wall section 50b. The connection plate portion 207 has a rectangle shape extending in the direction Z. The connection plate portion 207 is capable of sliding on an accommodation surface 224 (refer to FIG. 22) of the container mount 220 in the toner-supply device 43. In the case in which the connection plate portion 207 contacts the accommodation surface 224 (sliding state), the connection plate portion 207 has a height (protruding range) such that the lower wall section 50b of the toner cartridge 502 can be prevented from contacting the accommodation surface 224.

The discrimination protrusion 208 has a plate-shape which protrudes from the lower wall section 50b towards the lower side (opposite to Y direction). The discrimination protrusion 208 is provided in order to prevent the toner cartridge 502 being inserted to the container mount 220 (toner-supply device 43) which corresponds to the different color from that of developer G (toner T) contained in the toner cartridge 502. The position and numbers of the discrimination protrusions 208 are different according to the colors of developer G (toner T) contained in the toner cartridge 502. In an example shown in FIG. 7 and so on, two are provided in each left and right side that is, four in total. The position and numbers of the discrimination protrusions 208 corresponds to the position and numbers of later-described discrimination grooves 225 (refer to FIG. 22) provided according to the colors with each container mount 220 in the toner-supply device 43. According to the cooperation between the discrimination protrusion 208 and the discrimination groove 225 (refer to FIG. 22), the toner cartridge 502 (502Y, 502M, 502C, and 502BK) can be inserted to the appropriate container mount 220 (toner-container fixing device 902) corresponding to the same color of developer G (toner T) as its own (contained developer G). Similarly, the toner cartridge 502 can be prevented from being inserted to the container mount 220 (toner-container fixing device 902) corresponding to a different color from its own (that is, mounting-error prevention).

The discrimination protrusion 208 is provided on both ends sandwiching the attachment mount 61 in a right and left direction. The discrimination protrusion 208 is surrounded by a later-described side wall section 50c, guide wall section 50d, and bottom wall section 50f. In other words, when viewing the discrimination protrusion 208 in a direction along the plane X-Y, the lower wall section 50b is provided on the upper side, the side wall section is provided on the outer side in the right and left direction, the guide wall section 50d is provided on the inner side in the right and left direction, and the bottom wall section 50f is provided on the bottom side. In addition, a rear wall section defining a rear surface (rear end portion) of the rear-end side (end side in the direction opposite to Z) of the lower wall section 50b is provided in the toner cartridge 502. Thereby, the insertion from a different direction than the direction Z is prevented so that the discrimination protrusion 208 is protected more accurately. Therefore, it is possible to prevent the mount-error of the toner cartridge 502 (502Y, 502M, 502C, and 502BK), and achieve an effect through the discrimination protrusion 208 which enables the insertion to the corresponding container mount 220 (toner-container fixing portion 902) more accurately.

As shown in FIGS. 4, 5, and so on, the holding rail 209 is provided on each side wall section 50c having a retention-releasing piece 68, in the toner cartridge 502. The holding rail 209 is configured by a plate member which protrudes from the corresponding side wall section 50c toward the outside in the right and left direction (direction X). Each holding rail 209 includes a rail body 209a and an inclined entry surface 209b. The rail body 209a extends in the direction Z along the side wall section 50c. The inclined entry surface 209b connects the end portion of the rail body 209a in the direction Z, and inclines toward the direction Y along the direction Z.

In addition, an extending rear section 210 is provided with the toner cartridge 502 on each end side of the side wall sections 50c (end sides in the direction opposite to Z). Each extending rear section 210 includes an extending rear wall 210a, a vertical rib 210b, and a plurality of horizontal ribs 210c. The extending rear wall 210a is configured by a plate member extending toward the outside in the right and left direction (direction X), and defines the rear end portion of the toner cartridge 502 in a nearly square shape, in relation to the container portion 51 decreasing in the size gradually toward the lower side (inside to outside), as shown in FIGS. 11 and 12. The extending rear wall 210a has a size so as to fit into an opening section 220a of the container mount 220 (refer to FIGS. 21A-22) without providing a clearance, through the cooperation between the extending rear wall 210a and the rear end portion of the toner cartridge 502. The vertical rib 210b is provided in parallel to the extending end wall 210a on the front side (direction Z) of the extending end wall 210a. The vertical rib 210b is configured by a plate member extending toward the outside in the right and left direction (direction X) from each side wall section 50c. The horizontal ribs 210c are provided in plural as bridges between the extending rear wall 210a and the vertical rib 210b in the direction Z. Therefore, in the extending rear section 210, the rigidity of the extending rear wall 210a is secured, at the same time as the reduction of the weight and materials can be achieved, by the arrangement of the vertical rib 210b and a plurality of horizontal ribs 210c.

A pair of guide wall sections 50d is provided with the toner cartridge 502. A shutter protector 50e is further provided in the front end of the guide wall section 50d on the right side in FIG. 13 (forward end portion in direction Z). The front end of the guide wall section 50d protrudes partially towards the direction Z and forms the shutter protector 50e. As described later, the shutter protector 50e is provided in the attachment mount 61 (lower wall portion 50b of toner cartridge 502). The shutter protector 50e protrudes over the first shutter 622 and the second shutter 632 in the direction Z, in the condition that the first shutter 622 and the second shutter 632 (shutter assembly 602) are provided so as to slide aside in the direction Z (refer to FIG. 17). In the case in which the toner cartridge 502 faces an unintended object when it is inserted in the direction Z, the shutter protector 50e contacts the object ahead of the first and second shutters 622 and 632. Thereby, the shutter protector 50e can prevent the first and second shutters 622 and 632 from being pushed toward the negative side of the direction Z relatively. Thus the first and second shutters 622 and 632 can be protected through the shutter protector 50e, by preventing them from being pushed by an unintended object.

As shown in FIGS. 6, 7, and 13, the bottom wall section 50f is provided on each lower end portion in the right and left direction of the attachment mount 61. Each bottom wall section 50f is provided as a bridge in the direction X between the side wall section 50c and the guide wall section 50d on the negative side of the direction Z thereof. A lower supporting piece 214 is provided with each bottom wall section 50f. The lower supporting piece 214 is provided in a pair on the bottom wall section 50f at an adjacent position to the rear side surface (negative side surface in direction Z). The lower supporting pieces 214 are provided on each outside of the bottom wall section 50f in the right and left direction (direction X). Both of the lower supporting pieces 214 protrude from the bottom wall section 50f toward the opposite direction to the direction Y. The protruding range thereof increases gradually toward the opposite direction to the direction Y. The first shutter 622 is provided with the lower wall section 50b of the toner cartridge 502 including those configurations as described.

As shown in FIG. 14, the first shutter 622 is formed to be plate-like as a whole, and includes a pair of side wall sections 71, a fixing piece 72, a releasing protrusion 73, a mount 74, a pair of engaging sections 75, and a pair of guide wall sections 76. A cutout portion 71a is formed on each side wall section 71. The end side of the direction Z of the side wall section 71 is unclosed with the cutout portions 71a. The length of the cutout portion 71a is determined at the extent in which the opposite side end portion in the direction Z does not open. In order to meet the above, a protruding stopper 71b protruding towards the negative side of the direction Y is provided in relation to the cutout portion 71a.

The fixing piece 72 includes a base end 72a and a body 72b. The protruding edge of the body 72b configures a pressure leg portion 72c. The releasing protrusion 73 is provided with the body 72b. The releasing protrusion 73 releases the fixing of the first shutter 622 on the sealing position by being pressed toward the direction Y.

The mount 74 is surrounded by the fixing piece 72 (including base end 72a) and the side wall sections 71, and includes a shutter seal 772 as a sealing member. The shutter seal 772 is fixed so as to be engaged to the mount 74. The shutter seal 772 seals the discharge outlet 55 (in order to seal passage of developer G), by being pressed by the attaching protrusion 61, around the discharge outlet 55 provided on the lower wall section 50b of the toner cartridge 502 (refer to FIG. 17). The front end portion 772a of the shutter seal 772 in the direction Z protrudes more than the front end portion 74a of the mount 74. The shutter seal 772 is composed of an elastic member such as a sponge so that it can adhere tightly around the discharge outlet 55 by its elastic deformation when it is pressed by the attaching protrusion 61 around the discharge outlet 55. As described, the sealing through the shutter seal 772 can be achieved (refer to FIG. 17).

A pair of engaging sections 75 includes hook surfaces 75a which are parallel to the X-Y plane on the opposite side of the direction Z. The engaging section 75 further includes a pressure surface 75b which is parallel to the X-Y plane in the direction Z.

A pair of guide wall sections 76 includes a guiding surface 76a which is parallel to the Y-Z plane. Each guiding surface 76a includes a guiding protrusion 76b. The guiding protrusion 76b can be engaged to the guiding recess 64 (refer to FIG. 13) provided with the attachment mount 61 of the lower wall section 50b of the toner cartridge 502. The guiding protrusion 76b is provided to be movable therein. The guiding recess 64 is defined by a piece 64a (refer to FIG. 13). The piece 64a can be held between the guiding protrusion 76b and the shutter seal 772 (refer to FIG. 14 and so on) provided with the mount 74 in the direction Y when the guiding protrusion 76b is inserted to the guiding recess 64 (refer to FIG. 13 and so on).

As shown in FIGS. 15A to 15C, the second shutter 632 is provided so as to cover the first shutter 622 and configured by a flat plate as a whole. The second shutter 632 includes a flat plate 782, a releasing protrusion 79, a pair of side wall sections 80, a pair of arm sections 812, and a pair of stoppers 82. The second shutter 632 further includes a supporting protrusion 211. The flat plate 782 is configured by a thin plate parallel to the X-Z surface, having a rectangular shape as a whole in the direction Z (on X-Z plane surface). The end portion on the opposite side of the direction Z of the flat plate 782 is configured to be flat and extends in parallel to the X-Y surface in the direction X.

The releasing protrusion 79 is provided on the flat plate 782. The end portion on the opposite side of the direction Z of the releasing protrusion 79 forms an inclination surface 79a. The flat plate 782 further includes a pair of side wall sections 80. An insertion recess 80a and an inclination surface 80b are provided with each of the side wall sections 80.

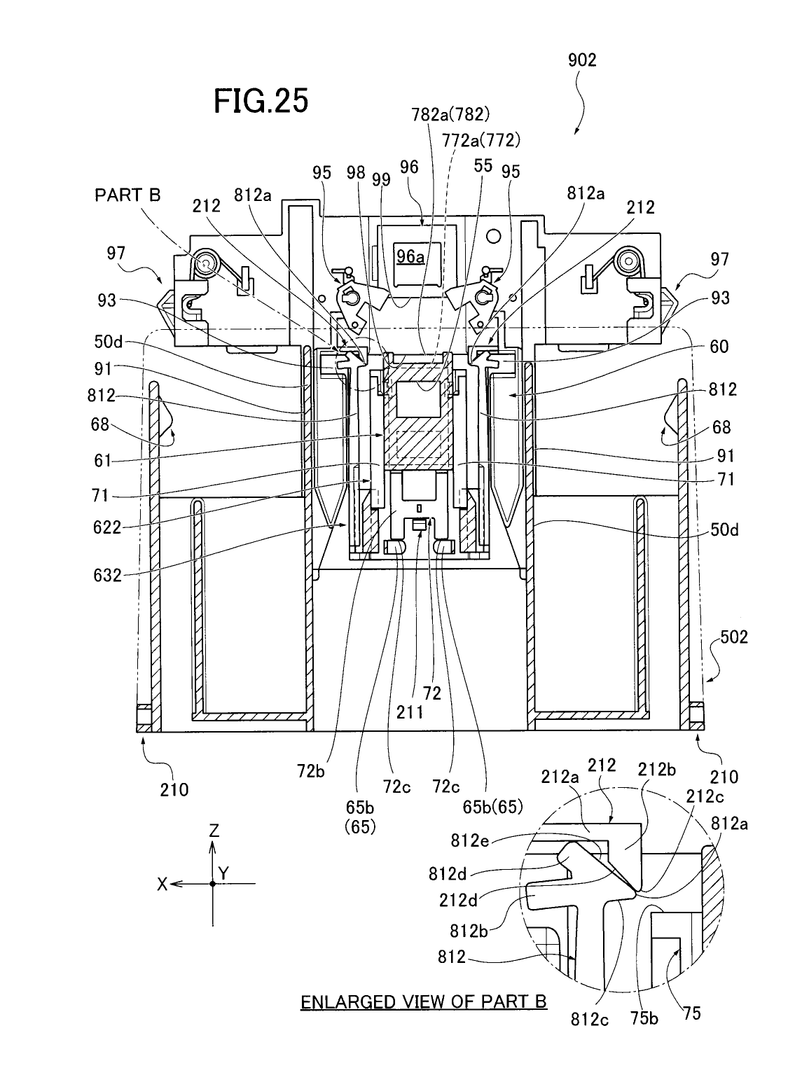

A pair of arm sections 812 protrudes from the end portion in the direction Z of the side wall sections 80 toward the direction Z. The arm sections 812 are configured by a bar-like member extending toward the direction Z. A distance between the arm sections 812 decreases gradually toward the direction Z. Each flat plate 66b of the support protrusion 66, provided on the lower wall section 50b of the toner cartridge 502, can be inserted between each arm section 812 and the flat plate 782, in which the arm sections 812 are movable. In addition, a pair of insertion recesses 80a which are provided adjacent to the arm sections 812 similarly accept the flat plate 66b of the support protrusion 66. Thereby, the second shutter 632 can be attached to the toner cartridge 502 (on lower wall section 50b thereof) so as to move in the direction Z. The first shutter 622 can be kept in between both arm sections 812. As described later, in the case in which the first and second shutters 622 and 632 are attached appropriately to the lower wall section 50b of the toner cartridge 502 (refer to FIG. 16 and so on), when the first shutter 622 moves toward the direction Z in relation to the second shutter 632, the side wall section 71 of the first shutter 622 contacts (is interfered by) the arm sections 812 (refer to FIG. 25 and so on).

An end portion 812a of each arm section 812 protrudes in the direction Z, and sharpens its end portion as viewed from the direction Y. The pointed end of each end portion 812a faces each other in the direction X. The interval between the end portions 812a is shorter than the width of the first shutter 622 (clearance between each side surfaces of side wall sections of first shutter 622 in direction X). Each arm section 812 includes a hook piece 812b adjacent to the protruding end portion 812a. Each hook piece 812b protrudes outward in the direction X from each arm section 812 (adjacent to protruding end portion 812a). The protruding edge thereof (outer end in direction X) is arranged on an identical plane to the outer surface of the side wall section 80 (outer wall surface in direction X). The above state is regarded as an initial curve-state of the arm sections 812. The arm section 812 is elastic and deformed in the direction X when a force to the direction X is applied. Then, the arm section 812 reverts to the initial curve-state when the force is released.

In the arm section 812, the surface on the negative side of the direction Z, around the protruding end portion 812a configures a plane surface 812c which is in parallel to the X-Y plane, in the initial curve-state. Therefore, when the arm section 812 has the above-described configuration (refer to FIG. 16), and the first shutter 622 moves in the direction Z in relation to the second shutter 632, the plane surface 812c contacts the front ends of each side wall section 71 of the first shutter 622. Herein, the plane surface 812c is in parallel to the X-Y plane and provided adjacent to each protruding end portion 812a. The front ends of each side wall section 71 of the first shutter 622 correspond to the pressure surface 75b of the engaging section 75 which is in parallel to the X-Y plane.

Each arm section 812 of the second shutter 632 includes the releasing protrusion 812d in the direction Z of the hook piece 812b. The releasing protrusion 812d protrudes from adjacent position to the protruding end portion 812a of the arm section 812 towards the outer side of the direction X and in the direction Z, and configures an inclined releasing surface 812e on the direction Z thereof. The inclined releasing surface 812e inclines gradually toward the direction Z along outer side in the direction X. The flat plate 782 which includes the arm section 812 further includes a pair of stoppers 82.

The supporting protrusion 211 is provided adjacent to the center of the flat plate 782 and at the position opposite to the direction Z over the releasing protrusion 79. The supporting protrusion 211 protrudes from the flat plate 782 toward the direction Y. The front surface of the supporting protrusion 211 in the direction Z is configured by a flat surface 211a which is in parallel to the X-Y plane. As described later, the supporting protrusion 211 is configured to have a size so that a bridge portion in the direction X (refer to 72d in FIG. 14) in the first shutter 622 can contact the flat surface 211a in the direction Z, when the first and second shutters 622 and 632 are provided appropriately on the lower-wall section 50b of the toner cartridge 502 (refer to FIG. 17). The bridge portion is provided with the body 72b in the fixing piece 72, having a shape like character H.

As shown in FIGS. 16 and 17, the first and second shutters 622 and 632 in the shutter assembly 602 can be provided on the lower wall section 50b of the toner cartridge 502. The first shutter 622 is attached to the attachment mount 61 through each guiding protrusion 76b in a pair of guide wall sections 76 which are inserted into a pair of guiding recess 64 provided with the attachment mount 61 on the lower wall section 50b of the toner cartridge 502. Thereby, the first shutter 622 can slide in the direction Z between the sealing position and the releasing position on the lower wall section 50b of the toner cartridge 502, due to the guiding function of the guiding recesses 64 and the guiding protrusion 76b inserted therein. In this state, the flat plate 66b of a pair of support protrusions 66 on the lower wall section 50b (inside portion 66e thereof as viewed from direction X as shown in FIG. 13) is inserted into the cutout part 71a on both side-wall sections 71 in the first shutter 622. The protruding stopper 71b (refer to FIG. 14) provided on the end portion of the cutout portion 71a in the negative side of the direction Z interferes with the protruding stopper 66d provided on the end portion of the flat plate 66b in the direction Z. Thereby, the first shutter is prevented from dropping out from the lower wall section 50b (that is, attachment mount 61) by moving toward the direction Z on the lower wall section 50b.

The second shutter 632 is attached through the flat plate 66b of the support protrusions 66 on the lower wall section 50b of the toner cartridge 502. The flat plate 66b is inserted into the insertion recess 80a in each side wall section 80. The second shutter 632 can slide in the direction Z between the covered position and the releasing position via the releasing position of the first shutter 622, through the guiding function of the insertion recesses 80a and a pair of support protrusions 66 being inserted thereto. The supporting protrusion 211 in the second shutter can mate with the body 72b (bridge 72d in direction X, in particular) when the second shutter moves toward the direction Z in relation to the first shutter 622. Accordingly, relative to the movement of the second shutter 632 further to the direction Z, the first shutter 622 can move from the releasing position toward the sealing position in the direction Z. Therefore, in the toner cartridge 502, the discharge outlet 55 can be sealed by the shutter seal 772, through the movement of the second shutter 632 in the direction Z so as to move the first shutter 622 to the sealing position.

The toner cartridge 502 provided with the shutter assembly 602 is inserted into the toner-supply device 43. The toner-supply device 43 includes the toner-container fixing portion 902 corresponding to the configuration of the shutter assembly 602. As shown in FIGS. 18 and 19, the toner-container fixing member 902 includes a guiding recess 91, a second insertion recess 92, a fixing groove 93, a first insertion recess 94, a fixing claw assembly 95, a supply port 96, and a releasing claw assembly 97. In addition, the toner-container fixing member 902 further includes a pressure portion 212 pushing the releasing protrusion and an assistance guide portion 213.

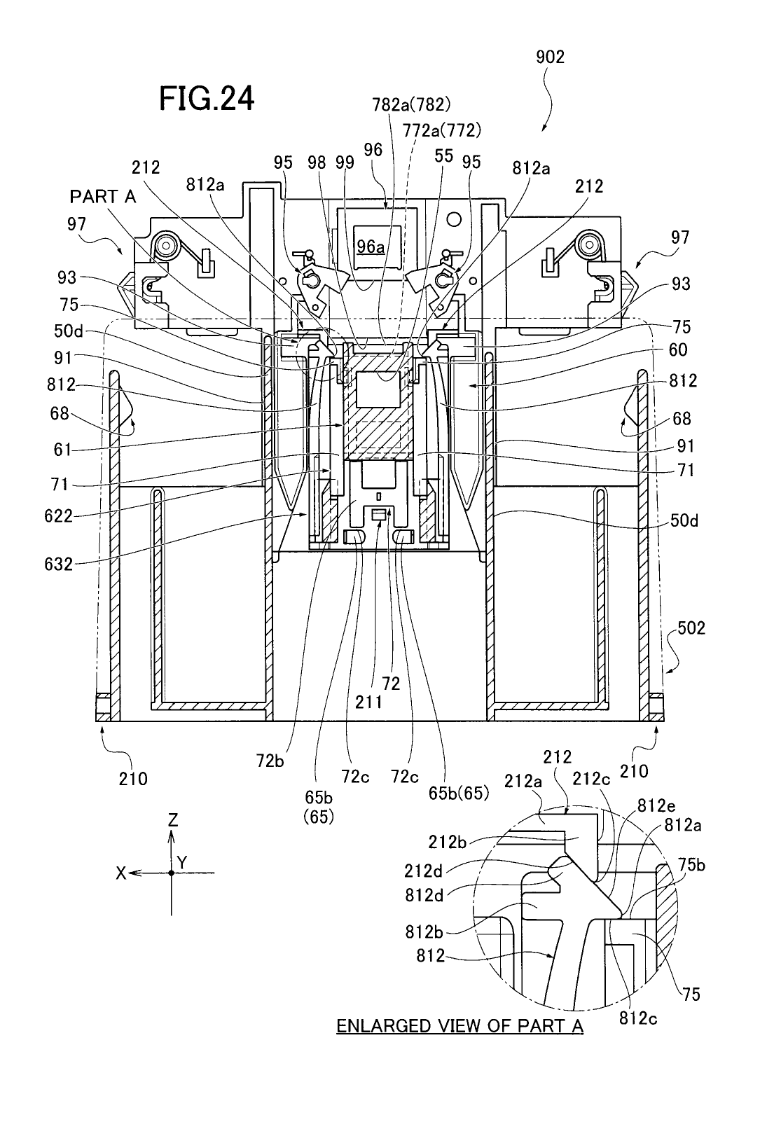

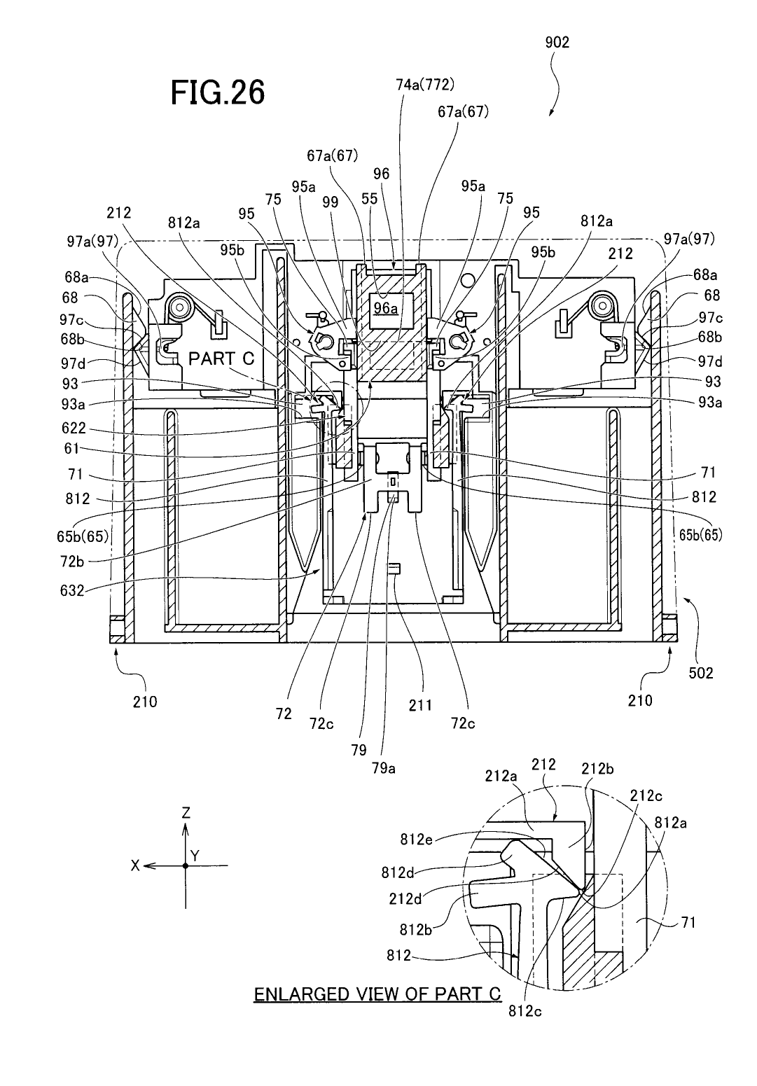

The guiding recess 91 is provided in a pair in the direction X. The guide wall sections 50d of the toner cartridge 502 can be inserted into the guiding recess 91 (refer to FIG. 24 and so on). The second shutter 632 in the shutter assembly 602 can be inserted into the second insertion recess 92 so that it is engaged thereto and movable in the direction Z (refer to FIG. 24 and so on). The fixing groove 93 is defined by a fixing wall section 93a in parallel to the X-Y plane on the opposite side of the direction Z. The fixing groove 93 is configured to have a size so that the hook piece 812b in the arm section 812 in the second shutter 632 (refer to FIGS. 15A-15C and so on) can be inserted thereto. The first insertion recess 94 is provided adjacent to the second insertion recess 92 in the direction Z. The first shutter 622 of the shutter assembly 602 in the toner cartridge 502 can be inserted movably into the first insertion recess 94 in the direction Z (refer to FIG. 26 and so on). Herein, the first shutter 622 is engaged to the first insertion recess 94. The first insertion recess 94 configures a second step portion 98 in between the second insertion recess 92.

The fixing claw assembly 95 includes a protrusion 95a on one side and a protrusion 95b on another side thereof. A surface of one end of the protrusion 95a fixes up the both side-wall sections of the attachment mount 61 of the toner cartridge 502. The protrusion 95b on another side can be arranged on the backward surface of the engaging section 75 (opposite side surface of hook surface 75a thereof) on both side wall sections 71 of the first shutter 622 in the toner cartridge 502 (refer to FIG. 26 and so on). The fixing claw assembly 95 is provided to be rotatable around the rotational axis 95c and a rotation force is added so as to take an initial curve-state (refer to an arrow A2 in FIG. 19). In addition, in the initial rotation state, each fixing protrusion 95a in the fixing claw assembly 95 can contact with the front end surface 67a of each releasing protrusion 67 in the attachment mount 61 of the toner cartridge 502 in the direction Z, when the toner cartridge 502 is mounted appropriately.

The supply port 96 is adjacent to the first insertion recess 94 in the direction Z. The central portion of the supply port 96 is provided with an aperture for a toner supply port 96a which is connected to the temporary toner chamber 44 (refer to FIG. 3) The supply port 96 forms a first step portion 99 in between the first insertion recess 94. The position of the upper end surface of the supply port 96 is arranged so as to contact with the lower end surface of the attachment mount 61 on surface to surface, in the condition that the toner cartridge 502 is inserted appropriately. The upper surface of the supply port 96 has an aperture for providing the toner supply port 96a in the direction Y. The lower end surface of the attachment mount 61 has an aperture for providing the discharge outlet 55 on the opposite side of the direction Y. In this configuration, the discharge outlet 55 and the toner-supply port 96a are connected so as to face each other in the direction Y.

The releasing claw assembly 97 adds a force to a releasing claw 97a so that an elastic pressure member 97b can take the initial-protruding position as shown in FIGS. 18 and 19. The releasing claw 97a includes a front side inclination 97c and a backward inclination 97d. In the releasing claw assembly 97, the position of the releasing claw 97a is regarded as the initial protruding position when it does not receive any force. The front end portion of the releasing claw 97a can be pushed into the toner-container fixing portion 902 against the elastic pressure member 97b.

The pressure portion 212 pressing the releasing protrusion is provided so as to shift the arm section 812 of the second shutter 632 toward the outside in the direction X corresponding to the insertion of the second shutter 632 into the second insertion recess 632. The pressure portion 212 is provided in a pair in the direction X so as to correspond to each arm section 812. Each pressure portion 212 includes a base member 212b which protrudes toward the inside of the end portion in the direction X of the fixing groove 93, as viewed from the right and left direction (direction X), and a pressure-body portion 212b which protrudes from the protruding end of the pressure-body portion 212b toward the opposite side of the direction Z. As described later, a size and position of the base member 212a are arranged so as not to prevent the hook piece 812b in the arm section 812 from entering into the fixing groove 93 (refer to FIGS. 24-26, and so on). The front end portion of the pressure body 212b on the opposite side of the direction Z (hereinafter, referred to as simply protruding end 212c) is provided so as to protrude toward the second insertion recess 92. Sequentially to the protruding end 212c, an inclined pressure surface 212d is provided. The inclined pressure surface 212d inclines toward the direction Z, from inside to outside in the direction X.

In each pressure portion 212 pressing the releasing protrusion, the pressure body 212b (protruding end 212c and inclined pressure surface 212d) is designed to have an even height to that of the corresponding arm section 812 (releasing protrusion 812d and inclined releasing surface 812e, in particular) of the second shutter 632 which is inserted to the second insertion recess 92. In each pressure portion 212, the protruding end 212c and the inclined pressure surface 212d of the pressure body 212b are provided at a position facing the inclined releasing surface 812e of the releasing protrusion 812d of the arm section 812 in the direction Z (refer to FIG. 24). The position of each pressure portion 212 is designed so that the protruding end 212c and the inclined pressure surface 212d of the pressure body 212b contact the inclined releasing surface 812e (the releasing protrusion 812d) of the arm section 812 before the second shutter 632 moves to the limit line defined by the second step portion 98 (refer to FIG. 24).

Therefore, in each pressure portion 212, the pressure body 212b contacts the releasing protrusion 812d of each arm section 812 in the initial-protruding state, when the second shutter 632 enters the second insertion recess 92 (refer to FIG. 24, and so on). As the second shutter 632 moves further in the direction Z, due to the interaction between the inclined releasing surface 812e of the protrusion 812d and the protruding end 212c and the pressure inclination surface 212d of the pressure body 212b, the pressure portion 212 shifts the hook piece 812b (outer end in direction X) of the arm section 812 to the position outside the side wall section 80 (its outer end). Thereby, the hook piece 812b enters into the fixing groove 93 (refer to FIG. 25, and so on).

A assistance guide portion 213 is provided on the end portion in the negative direction of the direction Z of a wall section between the guiding recess 91 and the second insertion recess 92. The assistance guide portion 213 includes an outside inclination surface 213a on the outside thereof as viewed from the right and left direction (direction X), and an inner side inclination surface 213b inside. The outside inclination surface 213a guides a pair of guide wall sections 50d toward the guiding recess 91 so that each guide wall section 50d can enter the guiding recess 91 smoothly. The inner side inclination surface 213b guides the second shutter provided with the second insertion recess 92 so that each guide wall section 50d can enter the second insertion recess 92 smoothly.

The toner-container fixing portion 902 is provided on the inner side of the container mount 220 of the image-forming apparatus 102 (refer to FIG. 20, and so on), as shown in FIG. 22. As shown in FIG. 20, the developing devices 23 are provided in parallel, in the horizontal direction (direction along X-Z plane). Corresponding to those, the photoreceptor drum 21, the transfer belt 30, the toner-supply device 43, and so on are provided in parallel in the horizontal direction (only tonner-supply device is shown in FIG. 20, though). In order to accommodate the toner cartridge 502, the image-forming apparatus 102 includes four container mounts 220 corresponding to yellow, cyan, magenta, and black. Each one corresponds to each color. The container mounts 220 are disposed in parallel in the horizontal direction corresponding to the developing devices 23 (toner-supply device 43) which are provided in parallel in the horizontal direction. Each container mount 220 accepts each one-color toner cartridge 502 (502Y, 502M, 502C, 502BK). Each of the container mounts 220 have nearly the same configuration, similar to the toner cartridge 502 and the toner-container fixing device 902, except that the discrimination groove 225 is provided as later described. Thus, a configuration of only one container mount 220 is shown in the description and FIGS. 21 and 22, and those of the other container mounts 220 are omitted herein.

As shown in FIGS. 21A to 22, the container mount 220 is accommodated with the image-forming device 102 through an opening section 220a of the outer wall section of the image-forming device 102. The container mount 220 has a rectangular-parallelepiped shape space into which the toner-container fixing portion 902 can be inserted. The opening 220 is an almost rectangle shape and has a size to which the end side portion similarly having an almost rectangle shape of the toner cartridge 502 can be inserted (refer to FIG. 21B) with no or almost no clearance allowed in between.

The container mount 220 includes a holding rail 221. The holding rail 221 is provided on each inner surface 220b of the container mount 220 in the right and left direction (direction X). Each holding rail 221 is configured by a flat plate member protruding from the inside of the corresponding inner surface 220b toward the right and left direction (direction X). As shown in FIG. 23B, when the toner cartridge 502 is inserted into the container mount 220, the holding rail 221 contacts the upper surface (surface in direction Y) of an inclined entry surface 209b of the holding rail 209 provided with the side wall section 50c of the toner cartridge 502. As shown in FIGS. 23B to 23C, when the toner cartridge 502 further moves to the direction Z, the holding rail 221 relatively moves to the upper side (direction Y) of a rail body 209a of the holding rail 209 and contacts the same from the upper side. Therefore, the toner cartridge 502 can be prevented from moving to the upper side (direction Y) and the attitude thereof is defined through the holding rail 221, in the container mount 220.

As shown in FIGS. 21 and 22, a holding piece 222 is provided with each inner side surface 22b of the container mount 220 on the upper side (direction Y) of the holding rail 221. The holding piece 222 protrudes from the corresponding inner side surface 220b toward the inside of the right and left direction (direction X). The protruding range thereof in the right and left direction increases gradually along the direction Z. The holding piece 222 has a size so as to sandwich the toner cartridge 502 (both sides) in the right and left direction (direction X), at least at a position in which the protrusion range is at the maximum.

As shown in FIG. 22, a pair of mount bases 223 is provided with the container mount 220 so as to cover both side portions in the right and left direction (direction X) of the toner-container fixing portion 902. The upper side surface of the mount base 223 is an accommodation surface 224 formed in a curve corresponding to the curved surface defined by the lower wall section 50b, in order to prevent interference which may occur in the lower wall section 50b (refer to FIG. 6) upon entering. When the toner cartridge 502 moves to the direction Z in the container mount 220, the connection plate portion 207 in the lower wall section 50b of the toner cartridge 502 (refer to FIG. 6, and so on) can be contact with and slide the accommodation surface 224. When the accommodation surface 224 contacts the connection plate portion 207, the accommodation surface 224 can be prevented from contacting the lower wall section 50b of the toner cartridge 502 due to the above-described configuration of the connection plate portion 207.

A discrimination groove 225 and an insertion groove 226 are provided with the mount base 223. The discrimination groove 225 prevents the toner cartridge 502 from being mounted to the container mount 220 (toner-container fixing portion 902) in relation to the color (yellow, cyan, magenta, and black) which is different from that of developer G (toner T) contained in itself. The discrimination groove 225 is recessed from the accommodation surface 224 to the negative side of the direction Y and extends in the direction Y. The size of the discrimination groove 225 is determined so as to accommodate the discrimination protrusion 208 (refer to FIG. 6 and so on) provided with the toner-container fixing portion 902. The number and the arrangement of the discrimination groove 225 are different according to the color of developer G contained in the corresponding toner cartridge 502. In the illustrated example, two discrimination grooves 225 are formed on either side, that is, four in total. With this configuration, the discrimination groove 225 allows the toner cartridge 502 to be inserted into only the container mount 220 corresponding to the same color.

The insertion groove 226 is positioned on the lateral outer side (direction X) in a lower portion of the mount base 223. The insertion groove 226 is recessed inward and extends in the direction Z. The insertion groove 226 can accept a retention-releasing piece 68 (refer to FIG. 16 and so on) provided with the toner cartridge 502 and allow the retention-releasing piece 68 to move in the direction Z to the releasing member 97 (releasing claw 97a shown in FIG. 18, and so on).

Descriptions are given below of operations of the shutter assembly 602 and the toner-container fixing portion 902 while inserting the toner cartridge 502 into the container mount 220 with reference to FIGS. 24 to 26. FIG. 24 is an explanatory view illustrating an aspect in which the toner cartridge 502 is inserted to the toner-container fixing portion 902. FIG. 24 includes a cross-sectional view of the toner cartridge 502 similar to FIG. 16 and a front view of the toner-container fixing portion 902 similar to FIG. 19. FIG. 24 further illustrates a pair of pressure portions 212 having a protrusion and opening. FIG. 24 also illustrates the pressure body 212b, protruding end portion 212c, and inclined pressure surface 212d of the pressure portions 212 having contact with the releasing protrusion 812d (and inclined releasing surface 812e thereof) of a pair of arm sections 812, as the initial-curve state of the second shutter 632 of the toner cartridge 502. FIG. 25 is an explanatory view similar to FIG. 24, and illustrates the second shutter 632 of the toner cartridge 502 having contact with the second step portion 98 of the toner-container fixing portion 902. FIG. 26 is an explanatory view similar to FIG. 24, and illustrates the discharge outlet 55 of the toner cartridge 502 in connection with the toner-supply port 96a of the toner-container fixing portion 902 (toner-supply device 43).

Initially, the toner cartridge 502 is held by grabbing the handle 206 (refer to FIGS. 21A, 21B, and so on) and moving it (including toner-container fixing portion 902) toward the insertion direction (direction Z) to the container mount 220, as indicated with the arrow A11 shown in FIG. 21A. At that time, a part of guide wall sections 50d (refer to FIG. 16, and so on) is inserted into a pair of guiding recesses 91 of the toner-container fixing portion 902 (refer to FIGS. 19 and 20, and so on), then, the connection plate portion 207 (refer to FIG. 6, and so on) provided with the lower wall section 50b of the toner cartridge 502 is mounted on each accommodation surface 224 (refer to FIG. 22) provided with the container mount 220. Thereby, the holding rail 221 in the container mount 220 contacts the corresponding holding rail 209 provided on a pair of side wall sections 50c of the toner cartridge 502 (refer to FIGS. 23A-23C) from the lower side. Each holding piece 222 sandwiches the toner cartridge 502 (side surfaces thereof) in the right and left direction (direction X). Thereby, the movement direction of the toner cartridge 502 corresponding to the toner-container fixing portion 902 is defined to the insertion direction (direction Z), as shown in FIG. 24)

As shown in FIGS. 16 to 17, the first shutter 622 is at the sealing position in the shutter assembly 602, and the shutter seal 772 is pressed on the attachment mount 61 around the discharge outlet 55 so as to seal the discharge outlet 55. The second shutter 632 is at the covering position in the shutter assembly 602, so the first shutter 622 including the releasing protrusion 73 is covered by the second shutter 632. Additionally, in the first shutter 622, the pressure-leg portion 72c in the body portion 72b of the fixing piece 72 contacts the pressed surface 65b of the fixing protrusion 65 in the direction Z. The pressure leg portion 72c can be prevented from moving from the pressed position toward the attachment mount 61 (toner cartridge 502) on the opposite side of the direction Z. Subsequently, in the second shutter 632, the plane surface 812c which is in parallel to the X-Y plane adjacent to the protruding-end portion 812a of the arm section 812 contacts the front end portion of the side wall sections 71 of the first shutter 622, that is, the pressure surface 75b which is in parallel to the X-Y plane of the engaging section 75. Thus, the second shutter 632 can be prevented from moving toward the opposite side of the direction X corresponding to the attachment mount 61 (toner cartridge 502) as shown in FIG. 16.

As the toner cartridge 502 moves toward the direction Z, the second shutter 632 of the shutter assembly 602 enters into the second insertion recess 92 of the toner-container fixing device 902. In the initial curve-state, the releasing protrusion 812d of the arm section 812 in the second shutter (inclined releasing surface 812e, especially) contacts the pressure body portion 212b of the releasing pressure protrusion 212 in the toner-container fixing portion 902 (protruding end 212c, that is, inclined pressure surface 212d) as shown in FIG. 24. When the toner cartridge 502 further moves toward the direction Z, due to the guiding function of the protruding end 212c of the pressure body portion 212b, the inclined pressure surface 212d, and the inclined releasing surface 812e of the releasing protrusion 812d, the arm section 812 changes its position (protrudes) toward the outer side as viewed from the direction X. Therefore, the hook piece 812b can enter into the fixing groove 93 which is connected to the second insertion recess 92 (refer to FIG. 25, and so on). In this condition, the second shutter 632 contacts the second step portion 98 of the toner-container fixing portion 902 (refer to FIG. 25). Therefore, the second shutter 632 is controlled so as not to move toward the direction Z relative to the toner-container fixing portion 902.

As shown in FIG. 26, along with the movement of the toner cartridge 502 in the direction Z, the lower end surface of the attachment mount 61 (negative side surface in direction Y) and the upper end surface of the supply port unit 96 (positive side surface in direction Y) contact each other by surface to surface contact. At the same time, the discharge outlet 55 of the attachment mount 61 faces the supply port 96a of the supply port unit 96 in the direction Y and being connected to the same. In this condition, the other end side protrusion 95b in the fixing-claw assembly 95 enters into the backward side of the engaging section 75 in the side wall section 71 of the first shutter 622 (front end portion 772a of shutter seal 772) as the releasing position on the control position defined by the first step portion 99. The front side surface 74a of the mount 74 in the first shutter 622 is determined as the control position defined by the first step portion 99.

In this case, in the first shutter 622, the front end portion 772a of the shutter seal 772 protrudes more than the front end surface 74a of the mount 74 in the direction Z (refer to FIG. 14, and so on). Accordingly, the protruding portion of the shutter seal 772 including the end portion 772a is compressed on the first step portion 99. Thus, in the condition that the discharge outlet 55 and the toner-supply port 96a are connected, the first step portion 99, that is, the interval between the discharge outlet 96 and the shutter seal 622, can be sealed at the compressed position in the shutter seal 772. Similarly, in addition, the hook piece 812b of the arm section 812 in the second shutter 632 enters into the fixing groove 93. The hook piece 812b is at the releasing position in the control position by the second step portion 98. Herein, in the arm section 812 of the second shutter 632, it is configured so that the releasing protrusion 812d contacts the pressure body 212b of the pressure portion 212, or the protruding end portion 812a contacts the side wall section 71 of the first shutter 622. Thereby, the arm section 812 keeps the deformed state so that the protruding end portion 812a extends along the direction Z at the same time as shifting towards the direction X. In the releasing piece 68 of the side wall section 50c of the toner cartridge 502, the lateral side of the inclination portion 68b faces the front side inclination portion 97c of the releasing claw 97a of the releasing claw assembly 97 in the direction Z. Thereby, the toner cartridge 502 is fixed to the toner-container fixing portion 902 releasably.

When the discharge outlet 55 and the toner supply port 96a are connected, the first positioning pin 951 provided with the container mount 220 (refer to FIG. 29) can be inserted into the first positioning hole 201 (refer to FIG. 4). The second positioning pin 952 (refer to FIG. 2) which is provided with the container mount 220 is inserted into the second positioning hole 202. Thereby, the toner cartridge 502 can keep the predetermined attitude corresponding to the container mount 220. Herein, the positioning protrusion provided with the container mount 220 is inserted into the position-adjustment hole 572b (refer to FIG. 4, and so on) on the electronic substrate 572 so that the electronic substrate 572 can be presented in the appropriate position.

In addition, while the toner cartridge 502 is moved in the direction Z so that the discharge outlet 55 and the toner supply port 96a are in a connected state, the holding piece 205 (refer to FIG. 4) which is provided on the upper surface of the toner cartridge 502 contacts the upper wall section 220c (refer to FIG. 22) of the container mount 220 so as to prevent the end portion side of the toner cartridge 502 from moving upward (refer to FIG. 21B, and so on). In addition, while the toner cartridge 502 is moved in the direction Z so that the discharge outlet 55 and the toner supply port 96a are in a connected state, the lower supporting piece 214 provided with the bottom wall section 50f of the toner cartridge 502 (refer to FIG. 6, and so on) contacts the lower wall section 220d (refer to FIG. 22) of the container mount 220 so as to prevent the back end side of the toner cartridge 502 from moving toward the lower side. Then, in condition that the discharge outlet 55 and the toner supply port 96a are connected, as shown in FIG. 21B, the opening section 220a of the container mount 220 is filled up with the back end portion of the toner cartridge 502. Thereby, the stirring drive coupling 301 provided with the container mount 220 is connected with the coupling 52a of the stirring member 52 (refer to FIG. 10D), and the transporting drive coupling provided with the container mount 220 is connected with the coupling 562a of the screw conveyor 56 (refer to FIG. 4, and so on).

From such a configuration, the toner cartridge 502 is inserted appropriately into the toner-container fixing portion 902, and the insertion operation of the toner cartridge 502 into the container mount 220 is completed. Therefore, when the toner cartridge 502 is inserted appropriately into the toner-supply device 43 (container mount 220), the stirring member 52 can rotate accordingly by the rotational drive force of the stirring-drive coupling, and the screw conveyor 56 can rotate appropriately receiving the drive force from the transporting-drive coupling. Thus, developer G which is discharged from the discharge outlet 55 of the toner cartridge 502 toward the outside can be reliably transported to the inner side (temporary toner chamber 44) from the toner supply port 96a of the toner-container fixing device (refer to FIG. 3). Therefore, developer G discharged from the toner cartridge 502 is supplied to the developing device 23 (refer to FIG. 3).

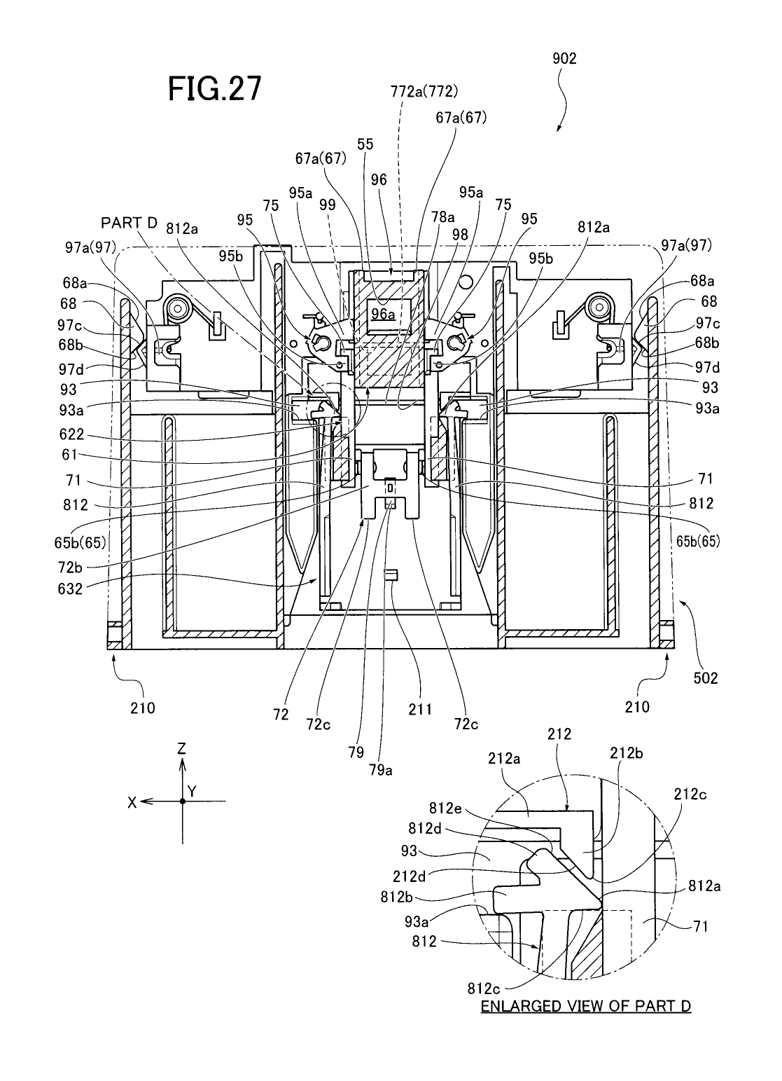

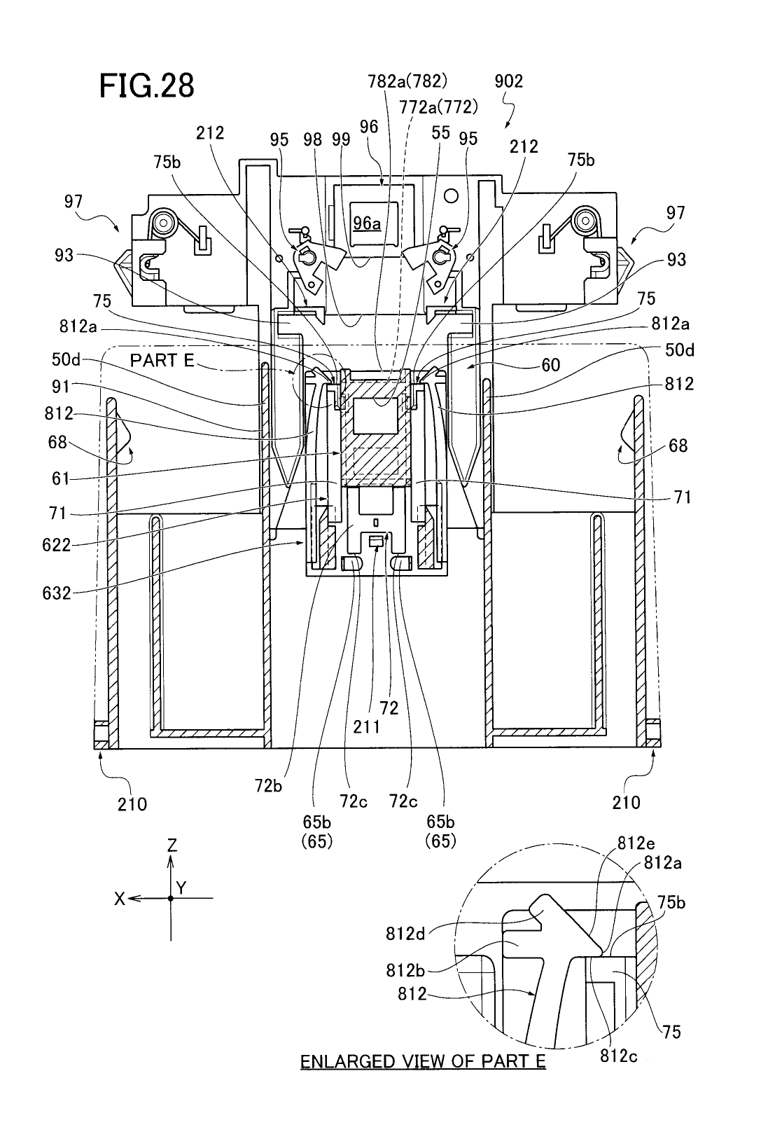

Descriptions are given below of operations of the shutter assembly 602 and the toner-container fixing portion 902 during releasing of the toner cartridge 502 from the container mount 220 with reference to FIGS. 27 and 28. FIG. 27 is an explanatory view similar to FIG. 24, illustrating an aspect in which the toner cartridge 502 is discharged. FIG. 27 illustrates a release aspect of the fixed toner cartridge 502 released by a pair of releasing claw assemblies 97 when the toner cartridge 502 moves to the opposite side of the direction Z relative to the toner-container fixing portion 902. FIG. 28 is an explanatory view similar to FIG. 24, and illustrates an aspect in which the second shutter 632, which is fixed by each hook piece 812b and fixing grooves 93, is released through the toner cartridge 502 moving toward the direction opposite to the direction Z relative to the toner-container fixing portion 902.

In the toner-container fixing portion 902, in order to eject the toner cartridge 502, the toner cartridge is moved to the opposite direction to the insertion direction, that is, the opposite side of the direction Z. In short, the release direction faces opposite to the direction Z. Herein, at first, the toner cartridge 502 is held by grabbing the handle 206 (refer to FIG. 21B, and so on) and moving the toner cartridge 502 from the container mount 220, that is, the toner-container fixing portion 902 is moved toward the release direction (opposite side of direction Z). Then, the fixed state through the releasing piece 68 on the side wall section 50c of the toner cartridge 502 and releasing claw assembly 97 is released (refer to FIG. 27). FIG. 27 illustrates the motion of the releasing claw assembly 97 (releasing claw 97a) of the toner-container fixing portion 902 being pushed inside thereof for the releasing operation. The attachment mount 61 of the toner cartridge 502 moves to the opposite side of the direction Z, and the condition in which the discharge outlet 55 faces the toner supply port 96a of the toner-container fixing portion 902 in the direction Y is released. Herein, in the shutter assembly 602, another end side protrusion 95b of the fixing claw assembly 95 in the toner-container fixing portion 902 enters into the backward side of the engaging section 75 (opposite side of direction Z of hook surface 75a thereof). Therethrough, the first shutter 622 is controlled so as not to move toward the opposite side of the direction Z in relation to the toner-container fixing portion 902 because the end side protrusion 95b contacts the hook surface 75a of the engaging section 75 in the direction Z. In the shutter assembly 602, the protruding end portion 812a of the arm section 812 in the second shutter 632 contacts the side wall section 71 of the first shutter 622 and the hook piece 812b enters inside the fixing groove 93 of the toner-container fixing portion 902. The hook piece 812b contacts (interferes) with the fixing wall section 93a of the fixing groove 93 in the direction Z. Thereby, the second shutter 632 is controlled so as not to move toward the opposite side of the direction Z. Herein, the second shutter 632 is moved slightly on the opposite side of the direction Z from the controlled position defined by the second step portion 98; however, it is still kept in the releasing position. When the arm section 812 in which the hook piece 812b is inserted into the fixing groove 93 recovers to the initial curve-state, through which there is slight movement toward the opposite side of the direction Z in the second shutter 632, the releasing protrusion 812d (inclined releasing surface 812e thereof) is prevented from interference between the pressure body 212b (protruding end 212c, and inclined pressure surface 212d thereof) provided with the pressure portion 812d of the toner-container fixing portion 902 (refer to FIG. 28, and so on). Therefore, in the toner cartridge 502, the first and second shutters 622 and 632 are prevented from moving toward the opposite side of the direction Z along with the attachment mount 61 (toner cartridge 502). That is, the first and second shutters 622 and 632 can keep the releasing position and move toward the direction Z.

When the toner cartridge 502 is moved toward the releasing direction (opposite side of the direction Z), the first shutter 622 is fixed on the controlled position defined by the first step portion 99 through the fixing claw assembly 95 until the first shutter 622 comes up to the position in which the shutter seal 772 (refer to FIG. 17) seals the discharge outlet 55. In such a position, the first shutter 622 moves to the sealing position of the toner cartridge 502. Subsequently, when the toner cartridge 502 is moved in the releasing direction (opposite side of direction Z), and the shutter seal 772 of the first shutter 622 is pushed and contacts with the discharge outlet 55 of the attachment mount 61 of the toner cartridge 502, the first shutter moves to the sealing position, and therefore, the discharge outlet 55 is sealed by the shutter seal 772 thereof. At that time, in the shutter assembly 602, the releasing protrusion 67 (front end surface 67a thereof) of the attachment mount 61 of the toner cartridge 502 moves to the opposite side of the direction Z over the one end protrusion 95a of the fixing claw assembly 95 of the toner-container fixing portion 902. Thereby, the condition in which the attachment mount 61 (releasing protrusion 67) pushes the one end protrusion 95a toward the direction Z is released. Therefore, the fixing claw assembly 95 takes the initial rotation state by rotating around the rotational axis 95c. The condition in which another end side protrusion 95b of the fixing claw assembly 95 in the toner-container fixing portion 902 enters into the backward side (opposite side of the direction Z of the hook surface 75a thereof) of the engaging section 75 in the side wall section 71 of the first shutter 622 is released. The first shutter 622 can move toward the opposite side of the direction Z in relation to the toner-container fixing portion 902. Therefore, when the toner cartridge 502 is moved toward the opposite side of the direction Z in relation to the toner-container fixing portion 902, the first shutter moves accurately to the sealing position, and the discharge outlet 55 of the attachment mount 61 can be reliably sealed by the shutter seal 772 of the first shutter 622.

Subsequently, when the toner cartridge 502 is further moved toward the releasing direction (opposite side of direction Z), the first shutter 622 of the shutter assembly 602 moves along with the toner cartridge 502 on the opposite side of the direction Z, and the second shutter stops adjacent to the controlled position defined by the second step portion 98. That is, the second shutter 632 moves toward the direction Z while the first shutter keeps the sealing position, in the toner cartridge 502. Then, the first and second shutters 622 and 632 relatively move in the direction Z. The releasing position in which the releasing protrusion 73 of the first shutter 622 faces the releasing protrusion 79 of the second shutter 632 in the direction Y is released so that the first shutter 622 is prevented from moving toward the opposite direction Z in relation to the toner cartridge 502 in the sealing position of the shutter seal 772 sealing the discharge outlet 55.

Subsequently, the toner cartridge 502 is moved in the releasing direction (opposite side of the direction Z), and the first shutter 622 of the shutter assembly 602 enters between the arm sections 812 provided with the second shutter 632. The condition of the arm section 812 in which the protruding end portion 812a contacts the side wall section 71 of the first shutter 622 is released (refer to FIG. 28). Therefore, the arm section 812 of the second shutter 632 takes the initial curved state so that the hook piece 812b is released from the condition entering into the fixing groove 93 of the toner-container fixing portion 902. The second shutter 632 can move toward the opposite side of the direction Z in relation to the toner-container fixing portion 902 (refer to FIG. 28). Herein, as described, since the second shutter 632 is prevented from interference between the pressure body portion 212b (protruding end 212c and pressure inclination surface 212d thereof) provided with the pressure portion 212 of the toner-container fixing portion 902, the arm section 812 in which the hook piece 812b is inserted into the fixing groove 93 can be securely returned to the initial curved state. At this time, the second shutter 632 moves to the covering position for preventing the releasing protrusion 73 of the first shutter 622 from being exposed toward the outside of the toner cartridge 502 (lower wall section 50b thereof) as shown in FIG. 28.

Subsequently, the toner cartridge 502 can be released from the toner-container fixing portion 902 (container mount 220) by being moved in the release direction (opposite side of direction Z). Herein, as shown in FIGS. 16, 17, and 28, in the shutter assembly 602, the first shutter is at the sealing position. The shutter seal 772 pushes the attachment mount 61 around the discharge outlet 55 so as to seal the same. The second shutter 632 is at the covering position and covers the first shutter including the releasing protrusion 73. Therefore, the toner cartridge 502 can be in a similar condition to that before it is inserted into the toner-container fixing portion 902 (container mount 220, and toner supply device 43), in which the shutter assembly 602 seals the discharge outlet 602. As described, the releasing operation of the toner cartridge 502 is completed.

Descriptions are given below of the features of the toner cartridge 502 (502Y, 502M, 502C, and 502BK) of Embodiment, with reference to FIGS. 29 to 31.

FIG. 29 is a perspective view of a cartridge receiver 950. The cartridge receiver 950 is provided on the internal side of the space included in the container mount 220 (refer to FIGS. 21A, 21B and 22) in the image-forming apparatus 102. In the cartridge receiver 950, a first positioning pin 951 and a second positioning pin 952 are provided on the right and left side ends, respectively. The first positioning pin 951 is provided on the opposite side of the direction X, and the second positioning pin 952 is provided on the direction X side. Both of the first and second positioning pins 951 and 952 protrude toward the opposite side of the direction Z.

The first positioning pin 951 faces a first positioning hole 201 (refer to FIG. 4 and so on) which is provided on the front end surface 50a of the toner cartridge 502. The second positioning pin 952 faces a second positioning hole 202 (refer to FIG. 4 and so on) provided on the same end surface 50a. The cross-section of the first positioning pin 951 is formed in a circle so as to fit the shape of a first positioning wall section 201a (refer to FIG. 4, and so on) provided in front of the first positioning hole 201. The outer diameter of the cross-section of the first positioning pin 951 is formed slightly smaller than the inner diameter of the first positioning wall section 201a. The cross-section of the second positioning pin 952 is formed in an ellipse so as to fit the form of a second positioning wall section 202a. The outer diameter (both longest and shortest diameter sides) of the second positioning wall section 202a is formed slightly smaller than the inner diameter (both longest and shortest diameter sides) of the second positioning wall section 202a.

An electronic-substrate connector 953 is further provided with the cartridge receiver 950. The electronic-substrate connector 953 is connected with the electronic substrate 572 (refer to FIG. 4 and so on). Herein, a sub-positioning pin 983a is provided in the center part of the electronic-substrate connector 953. The sub-positioning pin 953a is provided so as to face the position-adjustment hole 572b (refer to FIG. 4) in the electronic substrate 572.

The cartridge receiver 950 further includes the stirring-drive coupling 301 (refer to FIG. 10) and the transport-drive coupling 954. The stirring-drive coupling 301 faces the coupling 522a (refer to FIGS. 4, 10, and so on) of the stirring member 52, and the transport-drive coupling 301 faces the coupling 562a (refer to FIG. 4 and so on) of the screw conveyor 56. The stirring-drive coupling includes two protruding hooks 301a protruding on the opposite side of the direction Z. The transport-drive coupling 954 also includes two protruding hooks 954a. Herein, in FIG. 29, numeral 955 represents a motor, and numeral 956 represents a gear line configured of a gear 956a, 956b, 956c, 956d, and so on. The rotational force from the motor 955 is delivered via the gear line toward the transport-drive coupling 954 and the stirring-drive coupling and so on.

As described, the releasing piece 68 is provided on the side wall section 50c of the toner cartridge 502 (refer to FIG. 16 and so on). On the other hand, the releasing claw assembly 97 is provided with the toner-cartridge fixing portion 902 (container mount 220), as shown in FIG. 18 and so on). The releasing claw assembly 97 includes the front side inclination part 97c and the lateral side inclination part 97d and has a force toward the outside via the elastic pressure member 97b. Herein, the releasing piece 68 corresponds to the fixing protrusion, and the releasing claw assembly 97 corresponds to the movable protrusion, and both of these configure the retracting assembly.

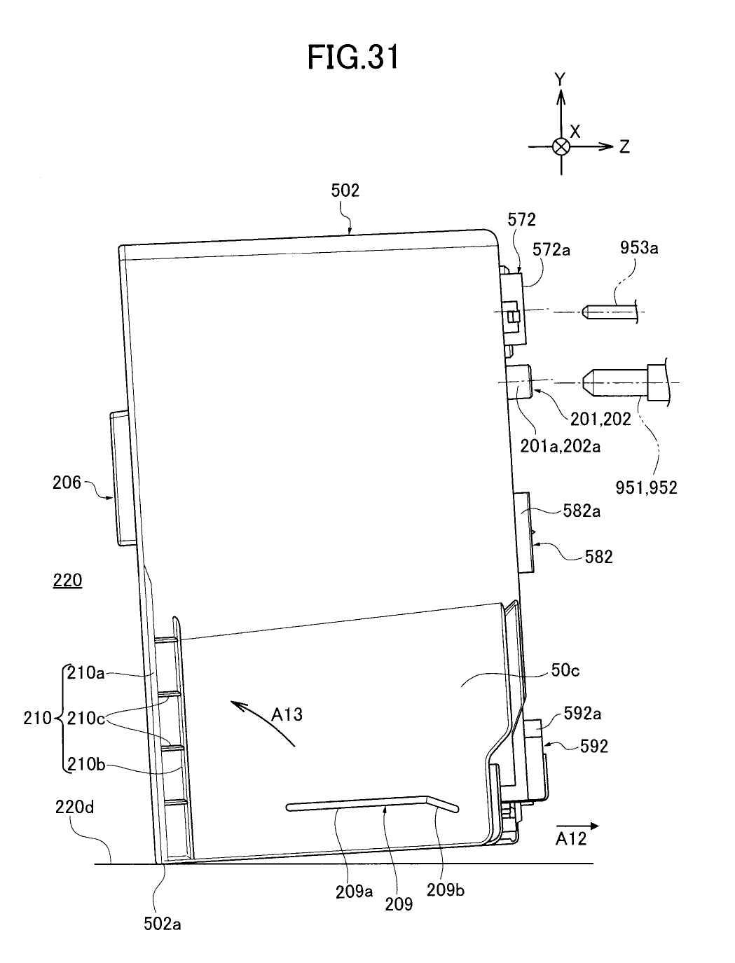

In order to insert the toner cartridge 502 into the container mount 220 of the image-forming apparatus 102, the toner cartridge 502 is pushed toward the container mount 220 in the direction indicated by an arrow A12 shown in FIG. 31. Thereby, the first positioning pin 951 fits to the first positioning hole 201 on the front end surface 50a of the toner cartridge 502, and the second positioning pin fits into the second positioning hole 202 on the front end surface 50a of the toner cartridge 502. The sub-positioning pin 953a fits into the position-adjustment hole 572b of the electric substrate 572. At the same time, the stirring-drive coupling 301 is connected with the connector portion 522a of the stirring member 52, and the transporting-drive coupling 954 is connected with the coupling 562a of the screw conveyor 56.

In Embodiment, as shown in FIGS. 4, 11, 21A and 21B, the holding pieces 205 are provided on both right and left sides of the upper surface of the toner cartridge 502 along the direction opposite to the direction Z. As shown in FIG. 13 and so on, on the lower side surface of the toner cartridge 502, the lower supporting pieces 214 are provided on both right and left sides in the direction opposite to the direction Z. Herein, the lower supporting pieces 214 configure the inclining-prevention portion.

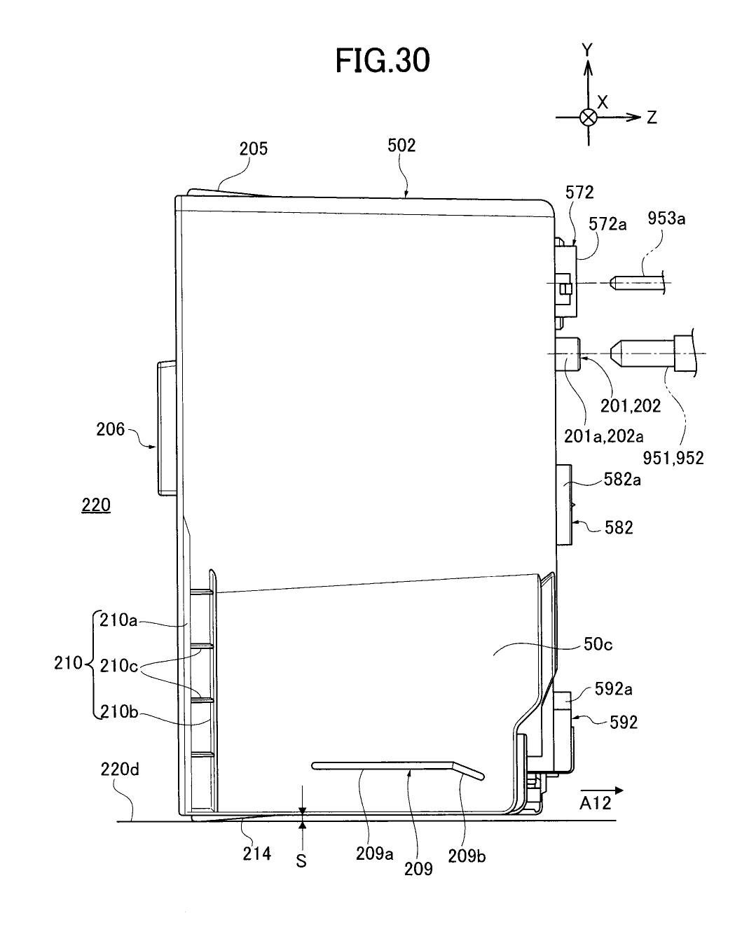

In particular, due to the arrangement of the lower supporting pieces 214 as shown in FIG. 30, the toner cartridge 502 can be kept in parallel to the lower wall section 220d of the container mount 220 of the toner cartridge 502, when it is inserted into the container mount 220. That is, even when the lower end of the toner cartridge 502 is retracted to the direction Z indicated by the arrow A12 by the retracting assembly, it does not incline upon being inserted into the container mount 220. In other words, the toner cartridge 502 is kept in parallel with the lower wall section 220d of the container mount 220. Therefore, it is configured to fit the first positioning hole 201 of the toner cartridge 502 to the first positioning pin 951 of the cartridge receiver 950 easily. Similarly, the second positioning hole 202 of the toner cartridge 502 can be fitted to the second positioning pin 952 of the cartridge receiver 950 easily. The position-adjustment hole 572b of the electric substrate 572 can be fitted to the sub-positioning pin 953a of the cartridge receiver 950 easily.

Herein, a description of a function of the retracting assembly is given below. As described, the retracting assembly includes the releasing piece 68 and the releasing claw assembly 97. When the toner cartridge 502 is inserted into the container mount 220, the releasing claw assembly 97 contacts the releasing piece 68. In detail, the releasing claw assembly 97 includes the front side inclination 97c and the lateral side inclination 97d, and the lateral inclination 97d of the releasing claw assembly 97 contacts the releasing piece 68 at first as shown in FIGS. 24-27. When the releasing claw assembly 97 which has the biasing force toward the outside moves further to the direction of A12, the front end surface (contact portion of inclination 97c and inclination 97d) contacts the releasing piece 68. In this condition, the releasing claw assembly 97 is pushed by the releasing piece 68.

When the releasing claw assembly 97 further moves in the direction A12, the front side inclination 97c of the releasing claw assembly 97 contacts the releasing piece 68. At this time, the releasing claw assembly 97 and the releasing piece 68 define a triangular-shape. A force toward the direction Z generated from the releasing claw assembly 97 has an effect on the releasing piece 68 because the releasing claw assembly 97 includes the biasing force toward the outside. As a result, the toner cartridge 502 is retracted by the retracting assembly.

On the other hand, in FIG. 31, the bottom surface of the toner cartridge 502 does not include any holding piece 205 as shown in FIG. 30. Thereby, when the toner cartridge 502 is inserted into the container mount 220 of the image-forming apparatus 102, it inclines slightly toward the lower wall section 220d of the container mount 220. That is, when the lower front end of the toner cartridge 502 is pulled to the direction Z side as indicated by the arrow A12 in the insertion operation, the toner cartridge 502 rotates toward the arrow A13 direction around the bottom surface end 502a in the center, and rotates slightly as a whole. As a result, the positioning hole 201 of the toner cartridge 502 cannot be fitted to the first positioning pin 951 of the cartridge receiver 950. Similarly, the second positioning hole 202 of the toner cartridge 502 cannot be fitted to the second positioning pin 952. Additionally, the position-adjustment hole 572b of the electric substrate 572 cannot be fitted to the sub-positioning pin 953a of the cartridge receiver 950.

As described, in Embodiment, the lower supporting piece 214 is provided on the bottom surface of the toner cartridge 502. Therefore, the toner cartridge 502 can keep its parallel attitude stably when it is retracted by the retracting assembly so as to be inserted into the container mount 220. Thus, the first positioning hole 201 can be fitted to the first positioning pin 951, and the second positioning hole 202 can be fitted to the second positioning pin 952 easily. The sub-positioning pin 953a of the electric substrate connector 953 can be fitted easily to the position-adjustment hole 572b of the electric substrate 572. As a result, the backward side end portion of the toner cartridge 502 can be fixed and held by the cartridge receiver 950 so that the toner cartridge 502 can be held stable in the container mount 220.

In addition, in Embodiment, the sub-positioning pin 953a of the electric substrate connector 953 can be easily fitted to the position-adjustment hole 572b of the electric substrate 572, so the electronic substrate connector 953 and the electric substrate 572 can be reliably connected to each other. As a result, the information exchange between the electronic substrate connector 953 and the electric substrate 572 can be performed accurately.

As shown in FIG. 30, it is arranged to have a slight clearance S between the bottom surface of the toner cartridge 502 and the lower wall section 220d of the container mount 220. By such a configuration, since at least the lower supporting piece 214 (protruding range, in particular) is manufactured with a high degree of accuracy, there is no need to arrange the whole bottom surface of the toner cartridge to have a high degree of accuracy. Therefore, manufacturing cost reduction can be achieved.

In the toner cartridge 502 (502Y, 502M, 502C, and 502BK), the holding piece 205 is provided on the upper surface thereof. Thus, it can prevent the back end side of the toner cartridge 502 from moving upward when the toner cartridge 502 contacts the upper wall section 220c (refer to FIG. 22) of the container mount 220. Therefore, such a configuration enables: the first positioning pin 951 (refer to FIG. 29) of the container mount 220 to fit into the first positioning hole 201 (refer to FIG. 4 and so on) appropriately; the second positioning pin 952 (refer to FIG. 29) of the container mount 220 to fit into the second positioning hole 202 (refer to FIG. 4 and so on) appropriately; the positioning protrusion of the container mount 220 to fit into the position-adjustment hole 572b (refer to FIG. 4 and so on) appropriately; the stirring-drive coupling 301 (refer to FIG. 10) to be connected to the coupling 522a of the stirring member 52 appropriately; and the transporting-drive coupling to be connected to the coupling 562a (refer to FIG. 4 and so on) of the stirring member 52. Such a configuration is remarkably effective because the handle portion 206 is provided on the rear surface (opposite side surface to direction Y) so as to carry the toner cartridge 502 easily by grabbing the handle wall section 206b with a hand inserted in the recess 206a.

In the toner cartridge 502 (502Y, 502M, 502C, and 502BK), the lower supporting piece 214 is provided on the bottom wall section 50f. Thus, it can prevent the back end side of the toner cartridge 502 from moving downward through contact with the lower wall section 220d (refer to FIG. 22) of the container mount 220. Therefore, the above-described appropriate engagement, insertion, or connection of each member can be achieved. In addition, the communication between the electric substrate 572 and the communication substrate provided with the container mount 220 (toner-supply device 43) can be prevented from becoming difficult due to the back end portion of the toner cartridge 502 inclining to the lower direction while being inserted to the container mount 220. This is remarkably effective because the back end portion of the toner cartridge 502 is easily inclined by moving to the lower direction by its own weight (weight amount of developer G housed in container portion 51).

In the toner cartridge 502 (502Y, 502M, 502C, and 502BK), the holding piece 205 on the upper surface contacts the upper wall section 220c, and the lower supporting piece 214 on the bottom wall section 50f contacts the lower wall section 220d so that an appropriate position can be taken as viewed from the up and down direction of the back end portion. Therefore, the above-described appropriate engagement, insertion, or connection of each member can be achieved. In addition, the holding piece portion 205 and the lower supporting piece 214 protrude gradually to the direction Y along the opposite side of the direction Z. Thus, the toner cartridge 502 can be inserted into the container mount 220 (toner-supply device 43) smoothly at the same time as achieving the above-described effects.

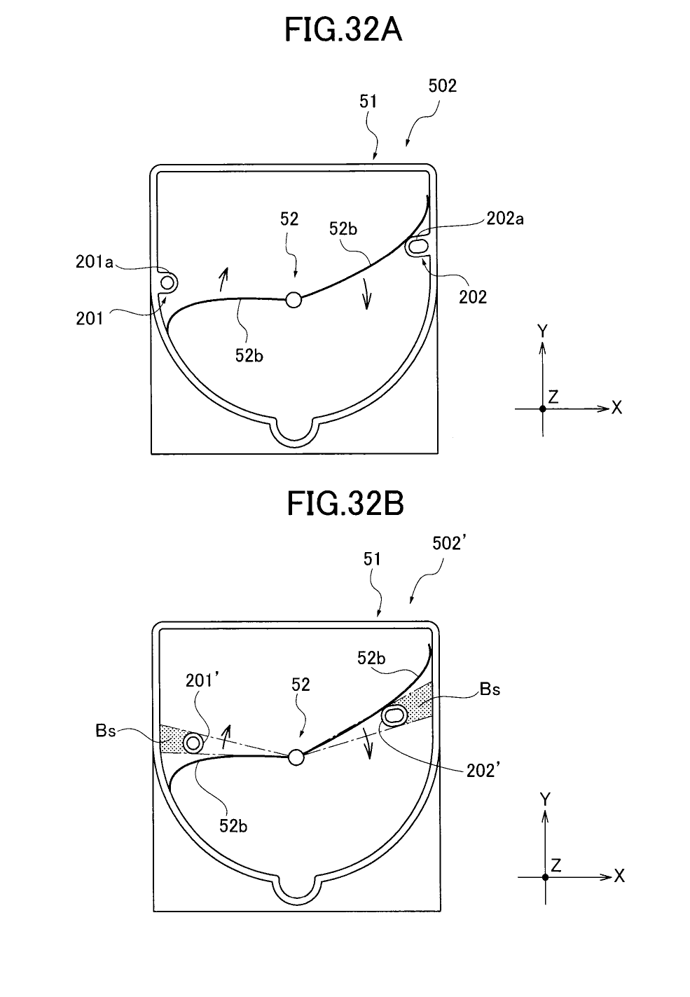

In the toner cartridge 502 (502Y, 502M, 502C, and 502BK), the first positioning wall 201a of the first positioning hole 201 and the second positioning wall section 202a of the second positioning hole 202 are connected to the container portion 51, that is, the internal surface of the toner cartridge 502. Thereby, the effect of stirring of the developer G housed in the container portion 51 through a stirring wing 52b (refer to FIG. 32A) of the stirring member 52 is enhanced furthermore. This can be described as follows: for example, in the toner cartridge 502′ as shown in FIG. 32B, the first positioning hole 201′ and the second positioning hole 202′ are not connected to the container portion 51, that is, a blind area Bs is formed by the inner surface of the toner cartridge 502, the first positioning hole 201′ and the second positioning hole 202′, between the container portion 51 and the inner wall section, when viewed from the shaft line of the stirring member 52; herein, the stirring wing 52b is provided so as to extend in a radial fashion from the shaft line; therefore, if the blind area Bs is formed, it becomes difficult to stir the developer G existing in the blind area Bs by the stirring wing 52b even if the stirring member 52 rotates. On the other hand, in the toner cartridge 502 of Embodiment, as shown in FIG. 32A, because the first positioning wall section 201a and the second positioning wall section 202a are connected to the inside surface thereof, developer G housed in the container portion 51 can be stirred by the stirring wing 52b evenly without such a blind area Bs. Therefore, the stirring effect of the developer G contained in the container portion 51 by the stirring wing 52b of the stirring member 52 can be enhanced. In this regard, for simplicity of description, although the inner side of the container portion 51 and the stirring wing 52b of the stirring member 52 are simplified, the difference in the stirring wing 52b is emphasized in FIG. 32. However, this does not illustrate the actual configuration, and is not the same in the other figures.

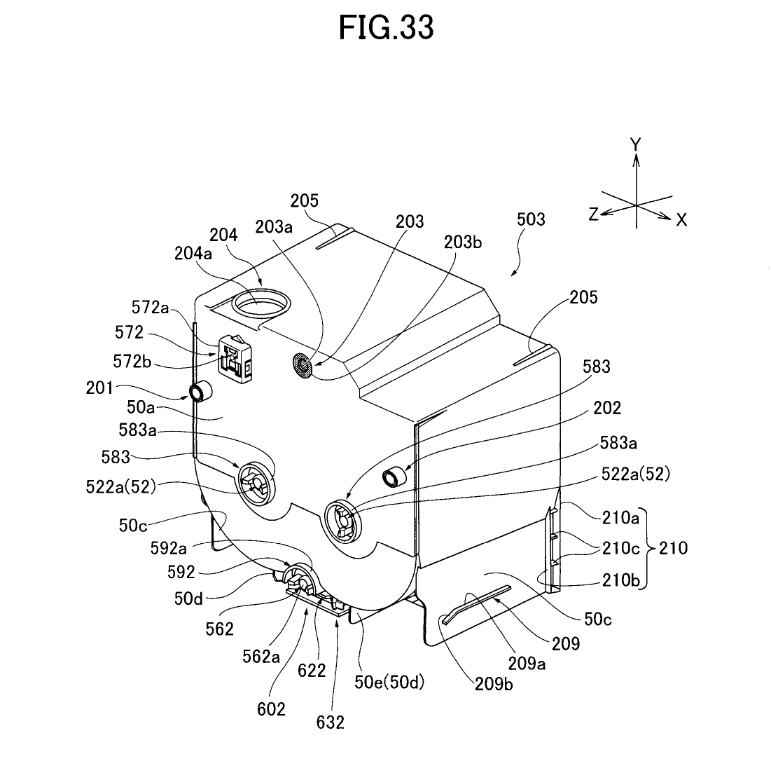

In above-described Embodiment, although the toner cartridge 502 includes a single stirring member 52, it can be replaced with a toner cartridge 503 including two stirring members 52 as shown in FIG. 33, and it is not limited the described embodiment. The toner cartridge 503 includes two connecting apertures 522a so as to expose the connecting portions 522a of the corresponding stirring members 52. The connecting apertures 583 have a similar configuration to the connecting aperture 58 or 582. The configuration of the toner cartridge 503 is similar to the toner cartridge 502 in Embodiment except for the two stirring members 52. The stirring force to developer G housed in the container portion 51 is advanced because it includes two stirring members 52.

Although the toner-container support unit according to the present invention has been described above in accordance with Embodiment, the detailed configuration is not limited thereto. It should be appreciated that variations may be made in the embodiments described by persons skilled in the art without departing from the scope of the present invention. The numbers, positions, forms, and so on of the described members are not limited to Embodiment, and they can be arranged appropriately with the operation of the present invention.

For example, in Embodiment, although the toner-supply unit 43 (toner-container fixing portion 902) is provided with the image-forming apparatus 102 as a color printer, it can also be provided with an image-forming apparatus forming a single color image. It is not limited to Embodiment.

According to Embodiment of the present invention, the toner container can be prevented from inclining when it is retracted by the retracting assembly because the inclination stopper portion is provided therein.

What is claimed is:

1. A toner-container support unit, comprising:
a toner container housing toner;
a container mount including an internal space to accommodate the toner container;
a toner-container receiver which is provided on an internal end side of the internal space of the container mount, fixing and supporting a back end surface of the toner container inserted into the container mount;
a positioning hole formed on the back end surface of the toner container;
a positioning pin provided in the toner-container receiver so as to face the positioning hole;
a retracting assembly retracing a back end portion of the toner container to the toner-container receiver side when inserting the toner container into the container mount, a position of the toner container being adjusted by fitting the positioning pin into the positioning hole through the retracting assembly retracting the back end portion of the toner container; and
an inclination stopper which prevents the inclination of the toner container when the back end portion of the toner container is retracted by the retracting assembly toward the toner-container receiver.

2. The toner-container support unit according to claim 1, further comprising:
an electronic substrate disposed on the back end surface of the toner container; and
a connector disposed in the toner-container receiver, which is connected to the electric substrate, wherein
a sub-positioning pin which is different from the positioning pin is disposed in the connector, and a positioning hole into which the sub-positioning pin is fitted is formed on the electronic substrate.

3. The toner-container support unit according to claim 1, further comprising:
a lower-support piece as the inclination stopper which is disposed on a front side of a bottom surface of the toner container, wherein
the lower-support piece is disposed on each right and left side along the insertion direction of the toner container and protrudes toward the lower side, and the protruding portion of the lower support piece increases at most on the front side and gradually decreases towards the back end side.

4. The toner-container support unit according to claim 1, wherein
the retracting assembly includes a fixed protrusion which is disposed on the back side of the toner container, and a movable protrusion which is disposed on the inner side of the container mount and has a biasing force toward the outside, wherein
when inserting the toner container into the container mount, the movable protrusion contacts the fixed protrusion and moves over the fixed protrusion while being pushed by the fixed protrusion, then the movable protrusion goes back by the biasing force so that the retracting assembly retracts the back end portion of the toner container to the toner-container receiver side.

5. The toner-container support unit according to claim 4, wherein
the fixed protrusion is disposed on the lower side of the back end portion of the toner container, and the movable protrusion is disposed on the lower side of the internal end portion of the container mount.

6. An image-forming apparatus comprising the toner-container support unit according to claim 1.
